(19) United States
(12) Patent Application Publication
(10) Pub. No.: US 2025/0163331 A1
(43) Pub. Date: May 22, 2025

(54) METHODS AND SYSTEMS FOR MIXING DISSIMILAR HYDROCARBON FEEDSTOCK MATERIALS TO FORM HYDROCARBON FEEDSTOCK BLENDS FOR SUBSEQUENT PROCESSING

(71) Applicant: HYDROCARBON TECHNOLOGY & INNOVATION, LLC, Lawrenceville, NJ (US)

(72) Inventors: David M. Mountainland, Princeton, NJ (US); Brett M. Silverman, Salt Lake City, UT (US); Paul Sadelski, Plainsboro Township, NJ (US)

(21) Appl. No.: 18/942,145

(22) Filed: Nov. 8, 2024

Related U.S. Application Data
(60) Provisional application No. 63/599,678, filed on Nov. 16, 2023.

(51) Int. Cl. C10G 1/00; B01F 25/40; B01F 33/80

(52) U.S. Cl. CPC C10G 1/002; B01F 25/40; B01F 33/834; C10G 2300/1003; C10G 2300/1007; C10G 2300/1014; C10G 2300/1018

(57) ABSTRACT

Methods and systems for mixing dissimilar hydrocarbon feedstock materials to form hydrocarbon feedstock blends for subsequent processing. The dissimilar hydrocarbon feedstock materials can differ by chemical composition, polarity, solubility, and/or physical state and include one or more of biomass-derived materials, non-petroleum-derived oils or fats, polymers, fabrics or textiles, paper or cardboard, rubber, waste products, pyrolysis products of the foregoing, or petroleum-derived materials. Efficient and thorough mixing of the dissimilar hydrocarbon feedstock materials is performed by static inline mixing to form an intermediate blend, which is further mixed by high shear mixing to form the hydrocarbon feedstock blend. The methods and systems may involve other processing equipment e.g., strainers, filters, pumps, furnaces, heat exchangers, reactors, separators, tanks, and/or distillation columns. The hydrocarbon feedstock blend may be further processed by hydrocracking or hydroconversion e.g., by ebullated bed, fixed bed, or slurry bed reactor), solvent deasphalting, coking, fluid catalytic cracking, hydroprocessing, or hydrotreating.

### CROSS REFERENCE TO RELATED APPLICATION

This Application claims the benefit of U.S. Provisional Application No. 63/599,678, filed Nov. 16, 2023, which is incorporated by reference in its entirety.

### BACKGROUND OF THE INVENTION

### 1. The Field of the Invention

The invention relates to methods and systems for blending dissimilar hydrocarbon feedstock materials to form hydrocarbon feedstock blends for subsequent processing, such as hydroprocessing, hydroconversion, hydrocracking, hydrotreating, solvent deasphalting, and/or coking.

### 2. The Relevant Technology

Converting heavy oil and other hydrocarbon feedstocks into useful end products often involves extensive processing, such as reducing boiling point, increasing hydrogen-to-carbon ratio, and removing impurities such as metals, sulfur, nitrogen, and coke precursors. Example hydroprocessing processes for upgrading heavy oil feedstocks, such as atmospheric tower bottoms and/or vacuum tower bottoms, include fixed bed hydroprocessing, ebullated bed hydroprocessing, slurry bed hydroprocessing, and moving bed hydroprocessing. Hydroprocessing can also be performed using a homogeneous catalyst in a slurry bed reactor.

There is an ever-increasing demand to more efficiently utilize low quality heavy oil feedstocks and extract fuel values therefrom. Low quality feedstocks are characterized as including relatively high quantities of hydrocarbons that nominally boil at or above 524° C. (975° F.). They also contain relatively high concentrations of asphaltenes, sulfur, nitrogen and metals. High boiling fractions derived from these low-quality feedstocks typically have a high molecular weight (often indicated by higher density and viscosity) and/or low hydrogen/carbon ratio, which is related to the presence of high concentrations of undesirable components, including asphaltenes and carbon residue. Asphaltenes and carbon residue are difficult to process and commonly cause fouling of conventional catalysts and hydroconversion equipment because they contribute to the formation of coke and sediment.

Low quality heavy oil feedstocks contain high concentrations of asphaltenes, carbon residue, sulfur, nitrogen, and metals. Examples include heavy crude, oil sands bitumen, and residuum left over from conventional refinery process. Residuum (or “resid”) can refer to atmospheric tower bottoms and vacuum tower bottoms. Atmospheric tower bottoms can have a boiling point of at least 343° C. (650° F.) although it is understood that the cut point can vary among refineries and be as high as 380° C. (716° F.). Vacuum tower bottoms (also known as “resid pitch” or “vacuum residue”) can have a boiling point of at least 524° C. (975° F.), although it is understood that the cut point can vary among refineries and be as high as 538° C. (1000° F.) or even 565° C. (1050° F.).

Increasingly, there is a need to process non-petroleum-derived feedstocks for the production of liquid and gas products, such as fuels and chemicals. These non-petroleum-derived feedstocks can include bio-derived materials, referred to as biomass (e.g., plant matter). Non-petroleum-derived feedstocks can also include plastics, such as high-density polyethylene, low-density polyethylene, polystyrene, polyethylene terephthalate, polypropylene, bisphenol-A, and/or polyvinyl chloride. They can also include waste or recycled material such as used cooking oil, plant-derived fats, animal-derived fats, rubber (especially waste tires), fabrics (textiles), paper or cardboard fiber, municipal solid waste, and sewage sludge. Any of the aforementioned categories can further include partially converted materials created from the listed non-petroleum feedstocks, which have been processed using techniques such as pyrolysis, cracking, coking, or the like.

In many cases, it may be desirable to form a mixture of two or more dissimilar hydrocarbon feedstocks that differ with respect to chemical composition, polarity, solubility, and/or physical state, making them somewhat or very difficult to mix to form sufficiently stable and/or homogeneous a hydrocarbon feedstock blend. While not always required, it will sometimes be advantageous to process one or more non-petroleum-derived materials as a mixture with a more “conventional” feedstock, typically a petroleum-derived material such as vacuum residue, vacuum gas oil, or other fractions from petroleum processing that are known in the art. Conventional feedstock materials can provide a uniform liquid matrix for the processing of the mixture and can provide useful hydrocarbon components which contribute to the formation of desired products when the mixture is converted and refined.

Alternatively, it may be advantageous in some cases to combine two or more feedstocks derived from non-petroleum sources and omit the use of conventional petroleum-derived materials. When non-petroleum-derived hydrocarbon feedstocks are converted in one or more suitable downstream processes, the capacity is maximized for the conversion of recycled or biomass-derived components.

However, a significant problem encountered when processing non-petroleum-derived feedstocks is the difficulty of forming stable liquid mixtures, which can be readily processed using typical conversion and refining equipment. Non-petroleum-derived feedstocks often have significant differences in chemical composition, polarity, solubility, physical state (e.g., liquid versus solid), and other properties relative to petroleum-derived feedstocks, and also relative to other types of non-petroleum-derived feedstocks, making it difficult to produce stable mixtures that are amenable to processing.

### SUMMARY

Disclosed herein are methods and systems which are configured to mix a plurality of dissimilar hydrocarbon feedstock materials to form hydrocarbon feedstock blends for subsequent processing. The dissimilar hydrocarbon feedstock materials differ with respect to chemical composition, polarity, solubility, and/or physical state and include one or more of biomass-derived materials, non-petroleum-derived oils or fats, polymers, fabrics or textiles, paper or cardboard, rubber, waste products, pyrolysis products of the foregoing, or petroleum-derived materials. The disclosed methods and systems overcome these difficulties by forming hydrocarbon feedstock blends of dissimilar materials which have sufficient stability and uniformity that allow them to be processed using various conversion and refining equipment.

In some embodiments, efficient and thorough mixing of the dissimilar hydrocarbon feedstock materials to form hydrocarbon feedstock blends can be performed by one or more static inline mixers to form an intermediate feedstock blend, which is further mixed by one or more high shear mixers to form well-mixed hydrocarbon feedstock blends. In an optional embodiment, the disclosed methods and systems also provide means to disperse an oil-soluble catalyst precursor into the hydrocarbon feedstock blend, which can enhance the efficiency and productivity of certain types of downstream processing units.

An example method for mixing a plurality of dissimilar hydrocarbon feedstock materials to form a hydrocarbon feedstock blend for subsequent processing comprises:
(1) providing a first hydrocarbon feedstock material selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof;
(2) providing a second hydrocarbon feedstock material that differs from the first hydrocarbon feedstock material by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof;
(3) mixing the first and second hydrocarbon feedstock materials by one or more static inline mixers to form an intermediate blend; and
(4) further mixing the intermediate blend by one or more high shear mixers to form the hydrocarbon feedstock blend.

In some embodiments, the first hydrocarbon feedstock material may comprise one or more non-petroleum-derived materials and the second hydrocarbon feedstock material may comprise one or more petroleum-derived materials. The inclusion of one or more petroleum-derived materials may be preferred in some cases for ease of processing using existing hydroprocessing systems commonly used in the petroleum industry. In other embodiments, the first and second hydrocarbon feedstock material may both comprise one or more non-petroleum-derived materials. In the case where one or more petroleum-derived materials are mixed with one or more non-petroleum-derived materials, the hydrocarbon feedstock blend may comprise at least about 1%, 3%, 5%, 10%, 15%, 20%, 30%, 40%, or 50% and less than about 99%, 97%, 95%, 90%, 85%, 80%, 70%, 60%, or 50%, by weight of the one or more petroleum-derived materials (or in a range defined by any two of the foregoing values) and at least about 1%, 3%, 5%, 10%, 15%, 20%, 30%, 40%, or 50% and less than about 99%, 97%, 95%, 90%, 85%, 80%, 70%, 60%, or 50%, by weight of the one or more non-petroleum-derived materials (or in a range defined by any two of the foregoing values).

In some embodiments, the method may further comprise mixing a third hydrocarbon feedstock material with the first and second hydrocarbon feedstock materials to form the hydrocarbon feedstock blend, wherein the third hydrocarbon feedstock material differs from the first and second hydrocarbon feedstock materials by at least one of chemical composition, polarity, solubility, or physical state, and wherein the third hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof. In some embodiments, the third hydrocarbon feedstock material may be pre-mixed with the second hydrocarbon feedstock material (e.g., by one or more static inline mixers) to form an initial blended feedstock material, which is then mixed with the first hydrocarbon feedstock material (e.g., by the one or more static inline mixers) to form the intermediate blend.

In some embodiments, the plurality of dissimilar hydrocarbon feedstock materials can be mixed using a single mixing line to form the hydrocarbon feedstock blend. In some embodiments, the hydrocarbon feedstock materials can be mixed using a plurality of (e.g., two) parallel mixing lines, each parallel mixing line including one or more static inline mixers, one or more high shear mixers, and at least one valve for regulating flow in the mixing line. Example methods and systems for blending hydrocarbon feedstock materials that incorporate two or more parallel mixing lines are disclosed in U.S. Pub. No. 2023/0383198, which is incorporated by reference in its entirety. An advantage of using two or more parallel mixing lines is that one of the mixing lines can be taken offline for maintenance without having to shut down the entire system, with the other mixing line(s) continuing to operate.

In some embodiments, such as where one or more non-petroleum-derived materials are solid at the temperature at which they are mixed with one or more other hydrocarbon feedstock materials, it can be advantageous to liquify and/or comminute any initially solid hydrocarbon feedstock materials to a particle size of about 50 mesh (about 300 μm) or smaller, or about 70 mesh (about 210 μm) or smaller, or about 100 mesh (about 150 μm) or smaller.

In some embodiments, it may be desirable to recycle a portion of the hydrocarbon feedstock blend back into the mixing system, such as by combining the recycled portion with at least one of the hydrocarbon feedstock materials prior to forming the intermediate blend.

In some embodiments, it may be desirable to disperse an oil-soluble catalyst precursor into the hydrocarbon feedstock blend, such as by initially mixing the oil-soluble catalyst precursor with a carrier oil to form a diluted precursor mixture that is mixed into the hydrocarbon feedstock blend, such as by at least one of inline mixing or high shear mixing. The carrier oil may include a petroleum-derived material or a non-petroleum-derived material such as any of the hydrocarbon feedstock materials used to form the hydrocarbon feedstock blend. In some embodiments, the carrier oil may include at least one of atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C. In some embodiments, nonpetroleum derived material or materials may form all or part of the carrier oil, all or part of the hydrocarbon feedstock, or both.

The catalyst precursor can be converted into an active catalyst in situ, such as by heating the hydrocarbon feedstock blend to thermally decompose the catalyst precursor and forming dispersed metal sulfide catalyst particles having high catalytic activity, which can beneficially promote beneficial upgrading reactions, such as when hydroprocessing the hydrocarbon feedstock blend.

The hydrocarbon feedstock blends can be processed by processing methods and systems known in the art, including one or more of hydrocracking or hydroconversion (e.g., by ebullated bed, fixed bed, or slurry bed reactor), solvent deasphalting, coking (delayed coking and/or Flexicoking), fluid catalytic cracking, hydroprocessing, or hydrotreating.

Systems for blending a plurality of dissimilar hydrocarbon feedstock materials to form a hydrocarbon feedstock blend for subsequent processing comprise means for performing the method steps disclosed herein. In addition to supply lines and mixers, such as the static-inline mixers and high shear mixers discussed herein, the system may further comprise processing equipment selected from the group consisting of strainers, filters, pumps, furnaces, heat exchangers, reactors, separators, tanks, and distillation columns.

An example system for mixing a plurality of dissimilar hydrocarbon feedstock materials to form a hydrocarbon feedstock blend for subsequent processing comprises:
(1) a first hydrocarbon feedstock stream selected from the group consisting of biomass-derived material, non-petroleum-derived oil or fat, polymer, fabric or textile, paper or cardboard, rubber, waste product, pyrolysis product of one or more of the foregoing, petroleum-derived feedstock material, and combinations thereof;
(2) a second hydrocarbon feedstock stream that differs from the first hydrocarbon feedstock stream by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived feedstock material, and combinations thereof;
(3) one or more static inline mixers configured to receive and mix the first and second hydrocarbon feedstock materials to form an intermediate blend; and
(4) one or more high shear mixers configured to receive and further mix the intermediate blend to form the hydrocarbon feedstock blend.

The methods and systems may include a plurality of different mixers and/or different types of mixers, such as static inline mixers, high shear mixers, surge tank(s) with pump around, and pumps used to feed the hydrocarbon feedstock blend to hydroprocessing or other reactor(s).

These and other advantages and features of the present invention will become more fully apparent from the following description and appended claims or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1 schematically illustrates an exemplary mixing system for mixing a plurality of dissimilar hydrocarbon feedstocks to form a hydrocarbon feedstock blend for subsequent processing;

FIG. 2 schematically illustrates another exemplary mixing system for mixing a plurality of dissimilar hydrocarbon feedstocks to form a hydrocarbon feedstock blend for subsequent processing;

FIG. 3 schematically illustrates another exemplary mixing system for mixing a plurality of dissimilar hydrocarbon feedstocks and optional catalyst precursor to form a hydrocarbon feedstock blend for subsequent processing;

FIG. 4 schematically illustrates an exemplary mixing system having parallel mixing lines and a bypass line for mixing a plurality of dissimilar hydrocarbon feedstocks and optional catalyst precursor to form a hydrocarbon feedstock blend for subsequent processing; and

FIG. 5 schematically illustrates another exemplary mixing system having parallel mixing lines and a bypass line for mixing a plurality of dissimilar hydrocarbon feedstocks and optional catalyst precursor to form a hydrocarbon feedstock blend for subsequent processing.

### DETAILED DESCRIPTION OF THE PREFERRED EMBODIMENTS

### I. INTRODUCTION

Disclosed are methods and systems configured to mix a plurality of dissimilar hydrocarbon feedstock materials to form hydrocarbon feedstock blends for subsequent processing. The dissimilar hydrocarbon feedstock materials differ with respect to chemical composition, polarity, solubility, and/or physical state and include one or more of biomass-derived materials, non-petroleum-derived oils or fats, polymers, fabrics or textiles, paper or cardboard, rubber, waste products, pyrolysis products of the foregoing, or petroleum-derived materials. The disclosed methods and systems overcome these difficulties by forming hydrocarbon feedstock blends of dissimilar materials which have sufficient stability and uniformity that allow them to be processed using various conversion and refining equipment.

In some embodiments, efficient and thorough mixing of the dissimilar hydrocarbon feedstock materials to form hydrocarbon feedstock blends can be performed by one or more static inline mixers to form an intermediate blend, which is further mixed by one or more high shear mixers to form well-mixed hydrocarbon feedstock blends. In an optional embodiment, the disclosed methods and systems also provide means to disperse an oil-soluble catalyst precursor into the hydrocarbon feedstock blend, which can enhance the efficiency and productivity of certain types of downstream processing units.

### II. DEFINITIONS

The term “dissimilar hydrocarbon feedstock materials” refers to two or more materials which differ with respect to chemical composition, polarity, solubility, and/or physical state. Examples of hydrocarbon feedstock materials that can be used in the disclosed processes and that may differ with respect to one or more of the foregoing properties include one or more of biomass-derived materials, non-petroleum-derived oils or fats, polymers, fabrics or textiles, paper or cardboard, rubber, waste products, pyrolysis products of the foregoing, petroleum-derived materials, or combinations thereof.

### A. Non-Petroleum-Derived Hydrocarbon Feedstock Materials

The term “biomass-derived material” refers to hydrocarbon-containing materials that are, contain, or come from biomass. “Biomass” is a term used in several contexts. In the context of ecology, it means living organisms, and in the context of bioenergy it means matter from recently living (but now dead) organisms. In the latter context, there are variations in how biomass is defined, e.g., only from plants, or from plants and algae, or from plants and fungi. The vast majority of biomass used for bioenergy and other processes, such as manufacturing biopolymers, comes from plants. Examples of biomass-derived materials that can be mixed and processed by methods and systems disclosed herein include, but are not limited to, plant-derived material, lignocellulose, cellulose, lignin, starch, wood, wood residues, sawdust, wood chips, energy crops, hemp, straw, wheat straw, barley straw, stover, grasses, switch grass, maize, miscanthus, bamboo, husks, bagasse, silage, agriculture waste, seaweed, kelp, algae, pyrolysis products of one or more of the foregoing, and combinations thereof.

The term “non-petroleum-derived oil or fat” refers to any oil or fat that generally comes or is derived from living organisms, such as plants and animals. Examples of non-petroleum-derived oils or fats that can be mixed and processed by methods and systems disclosed herein include, but are not limited to, vegetable oils and fats, seed oils, animal fats and proteins, used cooking oil, non-petroleum waxes, pyrolysis products of one or more of the foregoing, and combinations thereof.

The terms “plastic” and “polymer” refer to polymeric materials comprising repeating units, including homopolymers containing monomers bonded together as repeating units, copolymers containing multiple monomers bonded together in repeating units or blocks. The term “plastic” typically refers to thermoplastic polymers that have a melting or softening point and can be molded by heating to above the melting or softening point, forming the melt into a desired shape, and cooling the plastic in the desired molded shape. The term polymer more broadly covers thermoplastic polymers, as defined above, and thermoset polymers, which are typically provided as a resin that is formed into a desired shape and then caused to polymerize and/or cross-link via chemical and/or photoinitiation reactions. Examples of plastics and polymers that can be mixed and processed by methods and systems disclosed herein include, but are not limited to, high-density polyethylene (HDPE), low-density polyethylene (LDPE), polypropylene (PP), polystyrene (PS), polyester (PE), polyethylene terephthalate (PET), polybutylene terephthalate (PBT), polyetheretherketone (PEEK), polycarbonate (PC), acrylic, polymethacrylate, biopolymer, phenol-formaldehyde condensate, polyvinylchloride (PVC), bisphenyl-A, polyurethane (PUR), bioplastics, polyhydroxyalkanoate (PHA), polyhydroxy-butyrate (PHB), pyrolysis products of one or more of the foregoing, and combinations thereof.

The terms “fabric” and “textile” generally refer to finished or semi-finished products made from one or different types of fibers, such as natural fibers and/or synthetic fibers. Fabrics and textiles can be made from one or more different types of yarns or other fiber-based threads or materials include weaves, knits, non-wovens, and other fibrous structures joined together by one or more processes such as weaving, knitting, spreading, felting, stitching, crocheting, or bonding. Fibers used to make fabrics and textiles include natural fibers, synthetic fibers, and blends thereof. Examples of fabrics and textiles that can be mixed and processed by methods and systems disclosed herein include, but are not limited to cloth, clothing, towels, rags, upholstery, carpet, geotextiles, drapes, shades, blinds, baskets, tablecloths, bedding, sheets, blankets, shower curtains, flags, backpacks, tents, nets, balloons, kites, sails, and parachutes. Examples of materials used to make or which are derived from fabrics and textiles that can be mixed and processed by methods and systems disclosed herein include, but are not limited to, cotton, polyester, linen, jute, nylon, spandex, wool, silk, leather, other fabrics, pyrolysis products of one or more of the foregoing, and combinations thereof.

The terms “paper” and “cardboard” generally refer to a wide range of products made by mechanically or chemically processing cellulose fibers derived from wood, rags, grasses, or other vegetable sources in water, draining the water through a fine mesh leaving the fibers evenly distributed on the surface, followed by pressing and drying. Paper is a versatile material with many uses, including printing, painting, graphics, signage, design, packaging, decorating, writing, and cleaning. It may also be used as filter paper, wallpaper, book endpaper, conservation paper, laminated worktops, toilet tissue, currency, and security paper, or in a number of industrial and construction processes. Cardboard is a generic term for heavy paper-based products. The construction can range from a thick paper known as paperboard to corrugated fiberboard which is made of multiple plies of material. Natural cardboard can range from grey to light brown in color, depending on the specific product, and may contain dyes, pigments, printing, and coatings.

The terms “rubber” and “elastomer” refer to polymers with viscoelasticity (i.e., both viscosity and elasticity) and with weak intermolecular forces, generally low Young's modulus (E) and high failure strain compared with other materials. “Elastomer” is a portmanteau of “elastic” and “polymer” and often used interchangeably with “rubber”, although the latter is preferred when referring to vulcanizates. Each of the monomers which link to form the polymer is usually a compound of several elements selected from carbon and/or silicon, hydrogen, oxygen. Rubber-like solids with elastic properties are called elastomers. Polymer chains are held together in these materials by relatively weak intermolecular bonds, which permit the polymers to stretch in response to macroscopic stresses. Elastomers are usually thermosets (requiring vulcanization) but may also be thermoplastic (see thermoplastic elastomer). The long polymer chains cross-link during curing (i.e., vulcanizing). The elasticity is derived from the ability of the long chains to reconfigure themselves to distribute an applied stress. The covalent cross-linkages ensure that the elastomer will return to its original configuration when the stress is removed. Examples of rubbers, elastomers, and products made therefrom that can be mixed and processed by methods and systems disclosed herein include, but are not limited to, isoprene, neoprene, tires (e.g., used tires), polybutadiene, styrene-butadiene copolymer, butyl rubber, ethylene propylene rubber, styrene-ethylene-butylene-styrene (SEBS), acrylic rubber, thermoplastic elastomer (TPE), pyrolysis products of one or more of the foregoing, and combinations thereof.

The term “waste product” refers to products that are discarded or discharged from various industrial or municipal waste sources. Examples of rubbers, elastomers, and products made therefrom that can be mixed and processed by methods and systems disclosed herein include, but are not limited to, municipal solid waste (MSW), sewage sludge, food processing waste, meat-processing waste, industrial waste products, pyrolysis products of one or more of the foregoing, and combinations thereof.

The term “pyrolysis product” refers to products produced by thermal decomposition of hydrocarbon materials at elevated temperatures, typically in an inert atmosphere. Temperature can be understood as thermal vibration. At high temperatures, excessive vibration causes long chain molecules to break into smaller molecules. The word is coined from the Greek-derived elements pyro (“fire” or “heat”) and lysis (“separating”). Pyrolysis is most commonly used in the treatment of organic materials. In general, pyrolysis of organic substances produces volatile products and leaves char, a carbon-rich solid residue. Extreme pyrolysis, which leaves mostly carbon as the residue, is called carbonization. Pyrolysis is considered the first step in the processes of gasification or combustion. The process is used in the chemical industry, for example, to produce ethylene, many forms of carbon, and other chemicals from petroleum, coal, and even wood, or to produce coke from coal. It is used also in the conversion of natural gas (primarily methane) into hydrogen gas and solid carbon char, recently introduced on an industrial scale. Pyrolysis can convert biomass into syngas and biochar, waste plastics back into usable oil, and other wastes into safely disposable substances after removal of potentially valuable distillation products.

Pyrolysis is one of various types of chemical degradation processes that occur at higher temperatures (above the boiling point of water or other solvents). It differs from other processes, like combustion and hydrolysis, in that it usually does not involve the addition of other reagents such as oxygen (in combustion) or water (in hydrolysis). Pyrolysis produces solids (char), condensable liquids, (light and heavy oils and tar), and non-condensable gasses. Pyrolysis is different from gasification. In the chemical process industry, pyrolysis refers to a partial thermal degradation of carbonaceous materials that takes place in an inert (oxygen free) atmosphere and produces gases, liquids, and solids. Pyrolysis can be extended to full gasification that produces mainly gaseous output, often with the addition of water (as steam) to gasify residual carbonic solids, such as in steam reforming.

There are different types of pyrolysis. Carbonization is the complete pyrolysis of organic matter, which usually leaves a solid residue that consists mostly of elemental carbon. Destructive distillation is used in the manufacture of charcoal, coke, and activated carbon. Charcoal burning is used to produce charcoal. Tar production is performed by destructive distillation of wood in tar kilns. Cracking is used to convert heavier hydrocarbons into lighter ones, as in oil refining. Thermal depolymerization is used to break down plastics and other polymers into monomers and oligomers. Catagenesis is the natural conversion of buried organic matter to fossil fuels. Flash vacuum pyrolysis is used in organic synthesis.

Pyrolysis oil, sometimes referred to as bio-crude or bio-oil, is a synthetic fuel under investigation as substitute for petroleum. It is obtained by heating dried biomass without oxygen in a reactor at a temperature of about 500° C. (900° F.) with subsequent cooling. Pyrolysis oil is a kind of tar and normally contains levels of oxygen too high to be considered a pure hydrocarbon. This high oxygen content results in non-volatility, corrosiveness, immiscibility with fossil fuels, thermal instability, and a tendency to polymerize when exposed to air. As such, it is distinctly different from petroleum products. Oxygen can be removed from bio-oil and nitrogen from algal bio-oil by hydrotreating to form upgraded hydrocarbon products.

### B. Petroleum-Derived Feedstock Materials and Related Processes

“Heavy oil” and “heavy oil feedstock” refer to heavy crude, oil sands bitumen, bottom of the barrel and residuum left over from refinery processes, such as visbreaker bottoms, and any other lower quality materials that contain a substantial quantity of high boiling hydrocarbon fractions and/or that include a significant quantity of asphaltenes that can deactivate a heterogeneous catalyst and/or cause or result in formation of coke precursors and sediment. Examples of heavy oils include, but are not limited to, Lloydminster heavy oil, Cold Lake bitumen, Athabasca bitumen, atmospheric tower bottoms, vacuum tower bottoms, residuum (or “resid”), resid pitch, vacuum residue (e.g., Ural VR, Arab Medium VR, Athabasca VR, Cold Lake VR, Maya VR, and Chichimene VR), pyrolysis oils, deasphalted liquids obtained by solvent deasphalting, asphaltene liquids obtained as a byproduct of deasphalting, and nonvolatile liquid fractions that remain after subjecting crude oil, bitumen from tar sands, liquefied coal, oil shale, or coal tar feedstocks to distillation, hot separation, solvent extraction, and the like. By way of further example, atmospheric tower bottoms (ATB) can have a nominal boiling point of at least 343° C. although it is understood that the cut point can vary among refineries and be as high as 380° C. Vacuum tower bottoms can have a nominal boiling point of at least 524° C., although it is understood that the cut point can vary among refineries and be as high as 538° C. or even 565° C.

“Asphaltene” and “asphaltenes” refer to materials in heavy oil that are insoluble in paraffinic solvents, such as propane, butane, pentane, hexane, and heptane. Asphaltenes can include sheets of condensed ring compounds held together by heteroatoms, such as sulfur, nitrogen, oxygen, and metals. Asphaltenes broadly include a wide range of complex compounds having from 80 to 1200 carbon atoms, with predominating molecular weights, as determined by solution techniques, in the 1200 to 16,900 range. About 80-90% of the metals in the crude oil are contained in the asphaltene fraction which, together with a higher concentration of non-metallic heteroatoms, render asphaltene molecules more hydrophilic and less hydrophobic than other hydrocarbons in heavy oil resids. In the case of non-petroleum-derived hydrocarbon feedstocks, particularly pyrolysis oil, there can be materials similar to petroleum-derived asphaltenes that are insoluble in heptane. For purposes of this disclosure, the terms “asphaltene” and “asphaltenes” shall refer to any hydrocarbon materials that are insoluble in heptane.

“High boiling hydrocarbon material” and “high boiling hydrocarbon” refer to hydrocarbons at a processing facility that have a nominal boiling point of at least about 524° C. Examples include, but are not limited to, vacuum residues (produced from crude oil after a series of separation processes, including vacuum distillation), vacuum tower bottoms (produced downstream from one or more hydroprocessing reactors after a series of separation processes, including vacuum distillation), other heavy oil feedstocks, deasphalted heavy oil, and/or a conditioned heavy oil feedstock that includes a catalyst precursor and/or dispersed catalyst.

“Medium boiling hydrocarbon material” and “medium boiling hydrocarbon” refer to hydrocarbons at a processing facility that have a nominal boiling point in range of about 200° C. to about 524° C. Examples include, but are not limited to, vacuum gas oil (which typically has a boiling range of 360-524° C.), atmospheric gas oil (which typically has a boiling range of 200°-360° C.), decant oil or cycle oil (which typically has a boiling range of 360°-550° C.), fluid catalytic cracking (FCC)-derived oil, slurry oil, waste motor oil, or other hydrocarbons having a nominal boiling point in a range of about 200° C. to 524° C.

“Hydrocracking” and “hydroconversion” refer to processes whose primary purpose is to reduce the boiling range of heavy oil and in which a substantial portion of the heavy oil is converted into products with boiling ranges lower than that of the original feed. Hydrocracking or hydroconversion generally involves fragmentation of larger hydrocarbon molecules into smaller molecular fragments having a smaller number of carbon atoms and a higher hydrogen-to-carbon ratio. The mechanism by which hydrocracking occurs typically involves the formation of hydrocarbon free radicals during thermal fragmentation, followed by capping of free radicals with hydrogen. The hydrogen atoms or radicals that react with hydrocarbon free radicals during hydrocracking can be generated at or by active catalyst sites.

“Hydrotreating” refers to processes whose primary purpose is to remove impurities such as sulfur, nitrogen, oxygen, halides, and trace metals from the feedstock and saturate olefins and/or stabilize hydrocarbon free radicals by reacting them with hydrogen rather than allowing them to react with themselves. The primary purpose is not to change the boiling range of the feedstock. Hydrotreating is most often carried out using a fixed bed reactor, although other hydroprocessing reactors can be used, examples of which are an ebullated bed hydrotreater and slurry phase hydrotreater.

“Hydrocracking” and “hydroconversion” may also involve the removal of sulfur and nitrogen from a feedstock as well as olefin saturation and other reactions typically associated with “hydrotreating”. The terms “hydroprocessing” and “hydroconversion” shall broadly refer to both “hydrocracking” and “hydrotreating” processes, which define opposite ends of a spectrum, and everything in between along the spectrum.

“Hydrocracking reactor” refers to any vessel in which hydrocracking (i.e., reducing the boiling range) of a feedstock in the presence of hydrogen and a hydrocracking catalyst is the primary purpose. Hydrocracking reactors are characterized as having one or more inlet ports into which heavy oil and hydrogen are introduced, an outlet port from which an upgraded feedstock or material is withdrawn, and sufficient thermal energy that promotes fragmentation of larger hydrocarbon molecules into smaller molecules, causing formation of hydrocarbon free radicals. Examples of hydrocracking reactors include, but are not limited to, slurry phase reactors (i.e., two-phase, gas-liquid system), ebullated bed reactors (i.e., three-phase, gas-liquid-solid system), and fixed bed reactors (i.e., three-phase system that includes a liquid feed trickling downward over or flowing upward through a fixed bed of solid heterogeneous catalyst with hydrogen typically flowing co-currently with, but possibly counter-currently, to the heavy oil).

“Hydrocracking temperature” refers to a minimum temperature required to cause significant hydrocracking of a heavy oil feedstock. In general, hydrocracking temperatures will preferably fall within a range of about 399° C. (750° F.) to about 460° C. (860° F.), more preferably in a range of about 418° C. (785° F.) to about 443° C. (830° F.), and most preferably in a range of about 421° C. (790° F.) to about 440° C. (825° F.).

“Gas-liquid slurry phase hydrocracking reactor” refers to a hydroprocessing reactor that includes a continuous liquid phase and a gaseous dispersed phase, which forms a “slurry” of gaseous bubbles within the liquid phase. The liquid phase typically comprises a hydrocarbon feedstock that may contain a low concentration of dispersed metal sulfide catalyst particles, which can behave colloidally or as a pseudo solute, and the gaseous phase typically comprises hydrogen gas, hydrogen sulfide, and vaporized low boiling point hydrocarbon products. The liquid phase can optionally include a hydrogen donor solvent.

“Gas-liquid-solid, 3-phase slurry hydrocracking reactor” is used when a solid catalyst is employed along with liquid and gas. The gas may contain hydrogen, hydrogen sulfide, and vaporized low boiling hydrocarbon products. The term “slurry phase reactor” shall broadly refer to both types of reactors (e.g., those with dispersed metal sulfide catalyst particles, those with a micron-sized or larger particulate catalyst, and those that include both).

“Solid heterogeneous catalyst”, “heterogeneous catalyst” and “supported catalyst” refer to catalysts typically used in ebullated bed and fixed bed hydroprocessing systems, including catalysts designed primarily for hydrocracking, hydroconversion, hydrodemetallization, and/or hydrotreating. A heterogeneous catalyst typically comprises a catalyst support structure having a large surface area and interconnected channels or pores and fine active catalyst particles, such as sulfides of molybdenum, nickel, cobalt, vanadium, tungsten, and/or iron, dispersed within the channels or pores. The pores of the support are typically of limited size to maintain mechanical integrity of the heterogeneous catalyst and prevent breakdown and formation of excessive fines in the reactor. Heterogeneous catalysts can be produced as cylindrical pellets, cylindrical extrudates, other shapes such as trilobes, rings, saddles, or the like, or spherical solids.

“Upgrade”, “upgrading” and “upgraded”, when used to describe a hydrocarbon feedstock that is being or has been subjected to hydroprocessing, or a resulting material or product, refer to one or more of a reduction in molecular weight of the feedstock, a reduction in boiling point range of the feedstock, a reduction in concentration of asphaltenes, a reduction in concentration of hydrocarbon free radicals, and/or a reduction in quantity of impurities, such as sulfur, nitrogen, oxygen, halides, and metals.

“Severity” refers to the amount of energy that is introduced into heavy oil during hydroprocessing and is related to the operating temperature of the hydroprocessing reactor (i.e., higher temperature is related to higher severity and lower temperature is related to lower severity at same or similar throughput) in combination with duration or residence time (which are inversely proportional to throughput). Increased severity generally increases the quantity of converted products produced by the hydroprocessing reactor, including both desirable products and undesirable products. Conversion and throughput also affect severity. For example, when temperature is increased and throughput is held constant, conversion typically increases for a given feedstock. In order to maintain temperature while increasing throughput (i.e., increasing the liquid hourly space velocity), which decreases residence time of the heavy oil in the reactor, more heat energy must be added to the system to offset the cooling effect of passing a greater quantity per unit time of initially cooler heavy oil into the reactor.

Desirable conversion products include hydrocarbons of reduced molecular weight, boiling point, and specific gravity, which can include end products such as naphtha, diesel, jet fuel, kerosene, wax, fuel oil, and the like. Other desirable conversion products include higher boiling hydrocarbons that can be further processed using conventional refining and/or distillation processes. Bottoms products of sufficient quality to be useful as fuel oil are other examples of desirable conversion products.

Undesirable conversion products include coke, sediment, metals, and other solid materials that can deposit on hydroprocessing equipment and cause fouling, such as interior components of reactors, separators, filters, pipes, towers, heat exchangers, and the heterogeneous catalyst. Low quality conversion products can refer to unconverted resid that remains after distillation, such as atmospheric tower bottoms (“ATB”) or vacuum tower bottoms (“VTB”), particularly which are of too low of quality to be useful as fuel oil or other desired use. Minimizing undesirable conversion products reduces equipment fouling and shutdowns required to clean the equipment.

In addition to temperature, “severity” can be related to one or both of “conversion” and “throughput”. Whether increased severity involves increased conversion and/or increased or decreased throughput may depend on the quality of the heavy oil feedstock and/or the mass balance of the overall hydroprocessing system. For example, where it is desired to convert a greater quantity of feed material and/or provide a greater quantity of material to downstream equipment, increased severity may primarily involve increased throughput without necessarily increasing fractional conversion. This can include the case where resid fractions (ATB and/or VTB) are sold as fuel oil, and increased conversion without increased throughput might decrease the quantity of this product. In the case where it is desired to increase the ratio of upgraded materials to resid fractions, it may be desirable to primarily increase conversion without necessarily increasing throughput. Where the quality of heavy oil introduced into the hydroprocessing reactor fluctuates, it may be desirable to selectively increase or decrease one or both of conversion and throughput to maintain a desired ratio of upgraded materials to resid fractions and/or a desired absolute quantity or quantities of end product(s) being produced.

For feedstocks other than heavy oil, the term “conversion” mean the feedstock material or component is converted to a more desirable product (or products). For heavy oil, “conversion” and “fractional conversion” refer to the proportion, often expressed as a percentage, of heavy oil that is converted into lower boiling and/or lower molecular weight materials. Conversion is expressed as a percentage of the initial resid content (i.e., components with boiling points greater than a defined residue cut point) that is converted to products with boiling points less than the defined cut point. The definition of residue cut point can vary and can nominally include 524° C. (975° F.), 538° C. (1000° F.), 565° C. (1050° F.), and the like. It can be measured by distillation analysis of feed and product streams to determine the concentration of components with boiling point greater than the defined cut point. Fractional conversion is expressed as (F−P)/F, where F is the quantity of resid in the combined feed streams and P is the quantity in the combined product streams, where both feed and product resid content are based on the same cut point definition. The quantity of resid is most often defined based on the mass of components with boiling point greater than the defined cut point, but volumetric or molar definitions can also be used.

The conversion of asphaltenes can be different than the overall conversion of heavy oil. For purposes of this disclosure, a useful definition of asphaltene conversion is based on the relative amounts of asphaltenes in the fresh feedstock and upgraded product, and can be defined by the following, which results in a decimal fraction between 0 and 1, which can be converted into a percentage by multiplying by 100:

Conv=[Asph (fresh feed)−Asph (products)]/Asph (fresh feed).

The asphaltene content of a recycle stream is internal to the process. When conversion of asphaltenes is too low compared to conversion of heavy oil as a whole, recycle buildup of asphaltenes can occur.

“Throughput” refers to the quantity (mass or volume) of feed material introduced into the hydroprocessing reactor per unit of time. Throughput can be expressed in volumetric terms, such as barrels per hour or per day, or in mass terms, such as metric tons per hour or per day. In common usage, throughput is defined as the mass or volumetric feed rate of only the heavy oil feedstock itself (for example, vacuum tower bottoms or the like). The definition normally excludes the quantity of diluents or other components that can be added to or included in the overall feeds to a hydroconversion unit, although a definition which includes those other components can also be used.

“Space velocity” and “liquid hourly space velocity” are related to the throughput of a particular reactor or reactor size but are normalized to remove the size (volume) of the reactor. Thus, a larger reactor can have twice the throughput but the same space velocity as a reactor with half the volume size. Therefore, an increase in space velocity is typically proportional to an increase in throughput for a given reactor size. Space velocity is inversely proportional to residence time of heavy oil in a reactor of given reactor size. “Longer space velocity” means higher residence time and reduced throughput.

“Production rate of converted products” is an absolute rate that can be expressed in volumetric terms, such as barrels per hour or per day, or in mass terms, such as metric tons per hour or per day. The “production rate of converted products” should not be confused with yield or efficiency, which are sometimes erroneously called “rate” (e.g., production rate per unit feed rate, or production rate per unit converted feed). It will be appreciated that the actual numeric values of both initial production rate of converted products and increased production rate of converted products are specific to an individual production facility and depend on the capacity of that facility. Therefore, it is valid to compare the production rate of the unit or facility in question before and after modification but not against a different unit or facility built with a different capacity.

“Fouling” refers to the formation of an undesirable phase (foulant) that interferes with processing. The foulant is normally a carbonaceous material or solid (e.g., sediment) that deposits and collects within the processing equipment. Equipment fouling can result in loss of production due to equipment shutdown, decreased performance of equipment, increased energy consumption due to the insulating effect of foulant deposits in heat exchangers or heaters, increased maintenance costs for equipment cleaning, reduced efficiency of fractionators, and reduced reactivity of the heterogeneous catalyst. Hydroprocessing equipment, such as mixing lines, require periodic maintenance to remove sediment and other foulants.

“Rate of equipment fouling” of a hydrocracking reactor can be determined by at least one of: (i) frequency of required heat exchanger clean-outs; (ii) frequency of switching to spare heat exchangers; (iii) frequency of filter changes; (iv) frequency of strainer clean-outs or changes; (v) rate of decrease in equipment skin temperatures, including in equipment selected from heat exchangers, separators, or distillation towers; (vi) rate of increase in furnace tube metal temperatures; (vii) rate of increase in calculated fouling resistance factors for heat exchangers and furnaces; (viii) rate of increase in differential pressure of heat exchangers; (ix) frequency of cleaning atmospheric and/or vacuum distillation towers; or (x) frequency of maintenance turnarounds.

### C. Other Definitions

“Catalyst precursor” and “dispersed catalyst precursor” refer to a compound, such as an oil-soluble organometallic compound, which contains or provides one or more catalyst metals, such as molybdenum, nickel, cobalt, vanadium, tungsten, and/or iron. The catalyst precursor can be oil-soluble and have a decomposition temperature in a range from about 100° C. to about 350° C., or in a range of about 150° C. to about 300° C., or in a range of about 175° C. to about 250° C. Example catalyst precursors include organometallic complexes or compounds, more specifically oil soluble compounds or complexes of transition metals and organic acids, having a decomposition temperature or range high enough to avoid substantial decomposition when mixed with hydrocarbon feedstock materials under suitable mixing conditions. When mixing the catalyst precursor with a carrier oil, it is advantageous to maintain the carrier oil at a temperature below which significant decomposition of the catalyst precursor occurs. One skilled in the art can select a mixing temperature profile that results in intimate mixing of a selected catalyst precursor without substantial decomposition prior to forming dispersed metal sulfide catalyst particles in situ.

Example catalyst precursors include, but are not limited to, molybdenum 2-ethylhexanoate, nickel 2-ethylhexanoate, cobalt 2-ethylhexanoate, tungsten 2-ethylhexanoate, molybdenum octoate, molybdenum naphthenate, molybdenum dithiocarbamate, molybdenum diothiophosphate, molybdenum diothiophosphinate, vanadium naphthenate, vanadium octoate, molybdenum hexacarbonyl, vanadium hexacarbonyl, and iron pentacarbonyl. Other catalyst precursors include transition metal salts comprising a plurality of transition metal cations (e.g., molybdenum, nickel, cobalt, vanadium, tungsten, and/or iron cations) and a plurality of organic anions, such as carboxylates and derivatives having at least 8 carbon atoms and that are at least one of (a) aromatic, (b) alicyclic, or (c) branched, unsaturated and aliphatic. By way of example, each carboxylate or derivative anion may have between 8 and 17 carbon atoms or between 11 and 15 carbon atoms.

Examples of carboxylate anions that fit at least one of the foregoing categories include carboxylate anions derived from carboxylic acids and derivatives thereof selected from the group consisting of 2-ethylhexanoic acid, octanoic acid, naphthenic acid, 3-cyclopentylpropionic acid, cyclohexanebutyric acid, biphenyl-2-carboxylic acid, 4-heptylbenzoic acid, 5-phenylvaleric acid, geranic acid (3,7-dimethyl-2,6-octadienoic acid), 10-undecenoic acid, dodecanoic acid, and combinations thereof. It has been discovered that transition metal (e.g., molybdenum, nickel, cobalt, vanadium, tungsten, and/or iron) catalyst precursors made using carboxylate anions derived from the foregoing carboxylic acids possess improved thermal stability.

Catalyst precursors with higher thermal stability can have a first decomposition temperature higher than 210° C., higher than about 225° C., higher than about 230° C., higher than about 240° C., higher than about 275° C., or higher than about 290° C. Such catalyst precursors can have a peak decomposition temperature higher than 250° C., or higher than about 260° C., or higher than about 270° C., or higher than about 280° C., or higher than about 290° C., or higher than about 330° C. The catalyst precursor may be selected based on the temperature of the materials being mixed, with a catalyst precursor having a higher decomposition temperature being preferred at higher mixing temperatures to prevent premature thermal decomposition.

“Diluted precursor mixture” refers to a mixture of a hydrocarbon carrier oil and catalyst precursor, which is used to disperse the catalyst precursor into a hydrocarbon feedstock. The carrier oil can be a conventional petroleum-derived diluent and/or a non-petroleum-derived material. Example petroleum-derived carrier oils include atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C. Example non-petroleum-derived carrier oils include any of the non-petroleum-derived materials listed above. However, in order to avoid premature thermal decomposition of the catalyst precursor when forming the diluted precursor mixture, at least a portion of the non-petroleum-derived carrier oil should be a liquid at a temperature below the decomposition temperature of the catalyst precursor. In the case of initially solid non-petroleum-derived materials, it may be necessary to treat them by one or more of pyrolysis (to form pyrolysis oil), forming a mixture with a carrier oil solvent, melting them (e.g., in the case of a polymer) as long as the melting point is less than the decomposition temperature of the catalyst precursor, or comminuting them to a particle size of about 50 mesh (about 300 μm) or smaller, or about 70 mesh (about 210 μm) or smaller, or about 100 mesh (about 150 μm) or smaller, and dispersing or dissolving the particles in another liquid carrier oil.

It can be advantageous to form a diluted precursor mixture when the hydrocarbon feedstock contains water (e.g., condensed water). Otherwise, the greater affinity of the water for the polar catalyst precursor can cause localized agglomeration of catalyst precursors, such as molybdenum 2-ethylhexanoate that are unstable when exposed to water, resulting in poor dispersion and formation of micron-sized or larger catalyst particles. In such cases, the carrier oil is preferably substantially water free (i.e., contains less than about 0.5%. 0.3%, or 0.1% by weight of water) to prevent formation of substantial quantities of micron-sized or larger catalyst particles. Water is not a problem with catalyst precursors (e.g., metal carbamates) that are not unstable when exposed to water.

“Dispersed metal sulfide catalyst particles” and “dispersed catalyst” refer to catalyst particles having a particle size below 1 μm (submicron, or sub micrometer), preferably less than about 500 nm, or less than about 250 nm, or less than about 100 nm, or less than about 50 nm, or less than about 25 nm, or less than about 10 nm, or less than about 5 nm. The term “dispersed metal sulfide catalyst particles” may include molecular or molecularly dispersed catalyst compounds. “Dispersed metal sulfide catalyst particles” typically excludes metal sulfide particles and agglomerates of metal sulfide particles that are larger than 1 μm.

“Molecularly dispersed catalyst” refers to catalyst compounds that are essentially “dissolved” or dissociated from other catalyst compounds or molecules in a hydrocarbon feedstock or suitable diluent. It can include very small catalyst particles that contain a few catalyst molecules joined together (e.g., 15 molecules or less).

“Conditioned feedstock” refers to a hydrocarbon feedstock into which a catalyst precursor has been combined and mixed sufficiently so that, upon decomposition of the catalyst precursor and formation of the active catalyst, the catalyst will comprise dispersed metal sulfide catalyst particles formed in situ within the feedstock.

“Residual dispersed catalyst particles” and “residual dispersed metal sulfide catalyst particles” refer to catalyst particles that remain with a hydrocarbon product when transferred from one vessel to another (e.g., from a hydroprocessing reactor to a separator and/or other hydroprocessing reactor). Residual dispersed metal sulfide catalyst particles may also remain in a liquid residual fraction or pitch after separation of a hydrocarbon product into distillates and residual liquid or pitch, such as by flash separation, hot separation, atmospheric distillation, vacuum distillation, or vacuum stripping.

### III. METHODS AND SYSTEMS FOR MIXING DISSIMILAR FEEDSTOCKS TO FORM FEEDSTOCK BLENDS

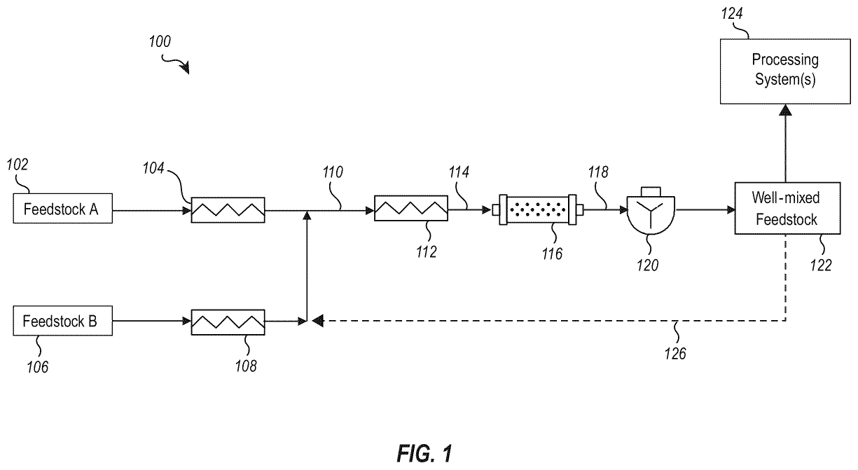

FIG. 1 schematically illustrates an example mixing system 100 and corresponding method for mixing dissimilar hydrocarbon feedstock materials to form hydrocarbon feedstock blends, which can be used for subsequent processing. For simplicity, FIG. 1 illustrates an embodiment where there are two different feedstocks to be combined, arbitrarily designated as Feedstock A and Feedstock B. Mixing system 100 includes feedlines for each of a first hydrocarbon feedstock material 102 and a second hydrocarbon feedstock material 106. In this embodiment, prior to being mixed with other hydrocarbon feedstock materials, the first hydrocarbon feedstock material 102 can be optionally premixed by optional static inline mixer 104 and the second hydrocarbon feedstock material 106 can be optionally premixed by optionally static inline mixer 108. Such premixing can be beneficial in cases where the feedstock materials are themselves a mixture of dissimilar materials and/or which are multi-phase so as to have liquid and solid components.

The first and second feedstock materials 102, 106 are combined into a combined feedstream 110 prior to mixing. The combined feedstream 110 is initially mixed by one or more static inline mixers 112 to form an intermediate blend 114, which can be passed through optional strainer 116 to form an optionally strained intermediate blend 118. The optionally strained intermediate blend 118 is then mixed by one or more high shear mixers 120 to form a well-mixed hydrocarbon feedstock blend 122. The well-mixed hydrocarbon feedstock blend 122 can be further processed by downstream processing system(s) 124. A side stream of the hydrocarbon feedstock blend 122 can optionally be recycled and combined with first and second hydrocarbon feedstock materials 102, 106. Such recycling may be desirable to effect more complete mixing, to maintain desired flow rates in various parts of the system, and the like.

In principle, Feedstock A and Feedstock B can be selected from any of the categories and types of hydrocarbon feedstock sources discussed herein. Normally, it will be expected that Feedstock A and Feedstock B will exhibit some degree of incompatibility or difficulty in mixing relative to one another. Otherwise, the mixing methods and systems would not be needed to produce a well-mixed hydrocarbon feedstock blend.

Typically, at least a portion of Feedstock A and/or Feedstock B will be an “unconventional” type of hydrocarbon material (e.g., non-petroleum-derived). For the purposes of the present invention, this can include any of a number of types of bio-derived and/or recycled hydrocarbon materials. This type of feedstock will exhibit one or more properties that make it difficult to process in downstream equipment and/or difficult to combine with other hydrocarbon feedstocks to create a uniform or stable mixture. For example, the hydrocarbon material may have poor solubility in other hydrocarbon feedstocks, such as due to relatively high oxygen content or relatively high polarity. Or it may be intrinsically non-homogeneous, such as containing solid particles (for example, unconverted plastic or pulverized tires). In some embodiments, at least a portion of Feedstock A and/or Feedstock B will be “conventional”, in that it will be a material derived from petroleum. For example, conventional feedstock materials could comprise a “straight-run” material, which is obtained directly by distillation of crude oil (e.g., by means of an atmospheric and/or vacuum distillation tower), or it could comprise any of a variety of materials obtained by further processing and conversion of petroleum feedstocks (e.g., heavy oil).

An example method for mixing a plurality of dissimilar hydrocarbon feedstock materials to form a hydrocarbon feedstock blend for subsequent processing using the mixing system 100 illustrated in FIG. 1 comprises:
(1) providing a first hydrocarbon feedstock material selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the first hydrocarbon feedstock by a static inline mixer;
(2) providing a second hydrocarbon feedstock material that differs from the first hydrocarbon feedstock material by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the second hydrocarbon feedstock by a static inline mixer;
(3) mixing the first and second hydrocarbon feedstock materials by one or more static inline mixers to form an intermediate blend, and optionally straining the intermediate blend to form a strained intermediate blend; and
(4) further mixing the optionally straining intermediate blend by one or more high shear mixers to form the hydrocarbon feedstock blend, and optionally recycling a portion of the hydrocarbon feedstock blend by combining the recycled portion with the first and/or second hydrocarbon feedstock materials.

In general, systems for mixing a plurality of dissimilar hydrocarbon feedstock materials to form a hydrocarbon feedstock blend for subsequent processing using the illustrated method associated with FIG. 1 comprise means (e.g., apparatus configured) for performing the steps recited in the preceding paragraph.

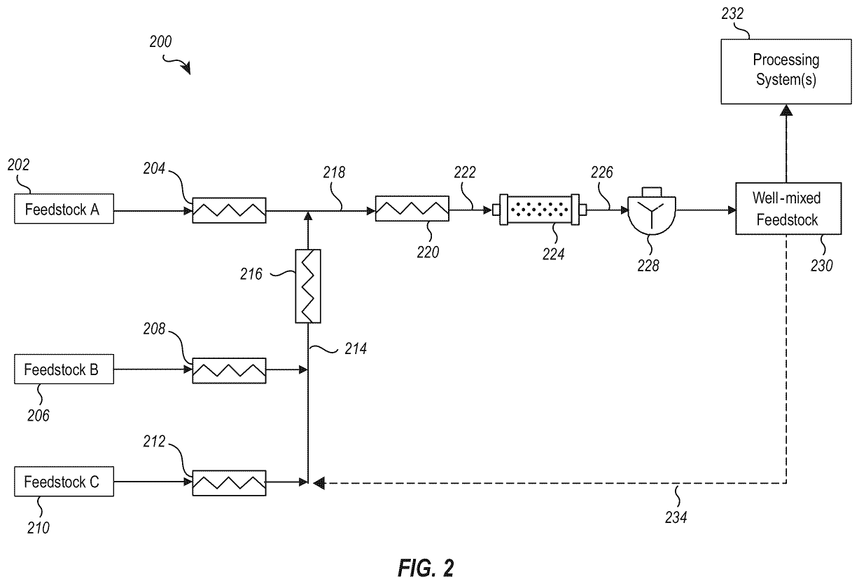

As noted above, some embodiments of the invention may include more than two hydrocarbon feedstock materials. FIG. 2 schematically illustrates an example configuration for combining three different hydrocarbon feedstock materials, arbitrarily designated as Feedstock A, Feedstock B and Feedstock C. FIG. 2 more particularly illustrates an example mixing system 200 and corresponding method for mixing three dissimilar hydrocarbon feedstock materials to form hydrocarbon feedstock blends, which can be used for subsequent processing. Mixing system 200 includes feedlines for each of a first hydrocarbon feedstock material 202, a second hydrocarbon feedstock material 206, and a third hydrocarbon feedstock material 210. In this embodiment, prior to being mixed with other hydrocarbon feedstock materials, the first hydrocarbon feedstock material 202 can be optionally premixed by optional static inline mixer 204, the second hydrocarbon feedstock material 206 can be optionally premixed by optional static inline mixer 208, and the third hydrocarbon feedstock material 210 can be optionally premixed by optional static inline mixer 212. Such pre-mixing may be beneficial in cases where the feedstock materials are a mixture of dissimilar materials and/or which are multi-phase so as to have liquid and solid components. FIG. 2 also shows that the second and third hydrocarbon feedstock materials 206, 210 can be combined into partial feedstream 214 and optionally premixed by optional static inline mixer 216. Premixing of partial feedstream 214 can be beneficial when the second and third hydrocarbon feedstock materials 206, 210 are particularly difficult materials to blend together.

The first, second, and third feedstock materials 202, 206, 210 are combined into feedstream 218 prior to mixing. The combined feedstream 218 is initially mixed by one or more static inline mixers 220 to form an intermediate blend 222, which can be passed through optional strainer 224 to form optionally strained intermediate blend 226. The optionally strained intermediate blend 226 is then mixed by one or more high shear mixers 228 to form a well-mixed hydrocarbon feedstock blend 230. The well-mixed hydrocarbon feedstock blend 230 can be further processed by downstream processing equipment 232. A portion of the well-mixed hydrocarbon feedstock blend 230 can optionally be recycled and combined with first, second, and third hydrocarbon feedstock materials 202, 206. 210. Such recycling may be desirable to effect more complete mixing, particularly if the second and third hydrocarbon feedstock materials 206. 210 are particularly difficult to blend, to maintain desired flow rates in various parts of the system, and the like.

An example method for mixing three (or more) dissimilar hydrocarbon feedstock materials to form a hydrocarbon feedstock blend for subsequent processing using the mixing system 200 illustrated in FIG. 2 comprises:
(1) providing a first hydrocarbon feedstock material selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the first hydrocarbon feedstock by a static inline mixer;
(2) providing a second hydrocarbon feedstock material that differs from the first hydrocarbon feedstock material by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the second hydrocarbon feedstock by a static inline mixer;
(3) providing a third hydrocarbon feedstock material that differs from the first hydrocarbon feedstock material and the second hydrocarbon feedstock material by at least one of chemical composition, polarity, solubility, or physical state, wherein the third hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the third hydrocarbon feedstock by a static inline mixer;
(4) optionally combining the second and third hydrocarbon feedstock materials to form a partial feedstream and premixing the partial feedstream by a static inline mixer;
(5) mixing the first, second, and third hydrocarbon feedstock materials by one or more static inline mixers to form an intermediate blend, and optionally straining the intermediate blend to form a strained intermediate blend; and
(6) further mixing the optionally straining intermediate blend by one or more high shear mixers to form the hydrocarbon feedstock blend, and optionally recycling a portion of the hydrocarbon feedstock blend by combining the recycled portion with the first, second, and/or third hydrocarbon feedstock materials.

In general, systems for mixing a plurality of dissimilar hydrocarbon feedstock materials to form a hydrocarbon feedstock blend for subsequent processing using the method illustrated associated with FIG. 2 comprise means (e.g., apparatus configured) for performing the steps recited in the preceding paragraph.

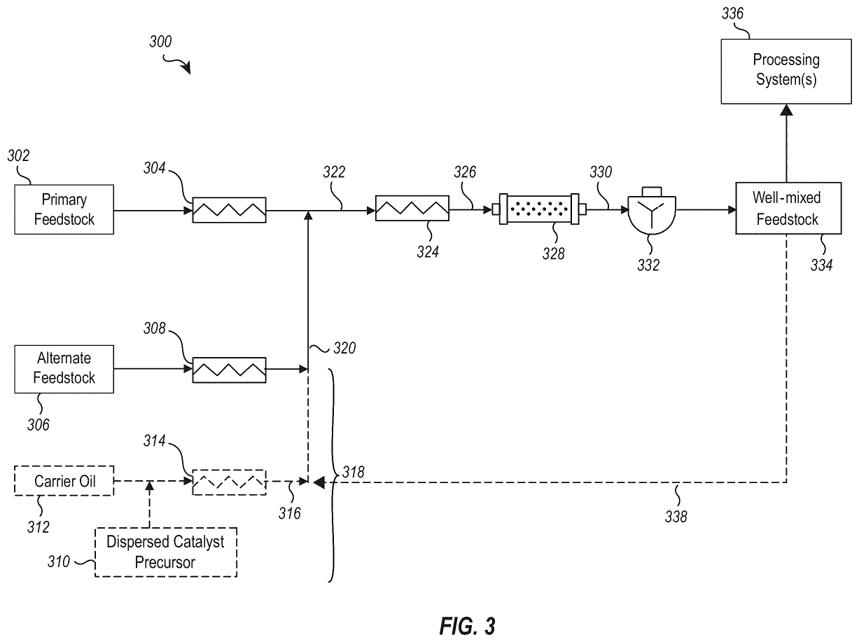

Optional embodiments of the invention include the optional addition of a dispersed catalyst precursor to the combination of hydrocarbon feedstock materials to be combined by the inventive mixing method. The optional dispersed catalyst can be used to improve the processing of bio-derived, plastic, and/or petroleum-derived feedstock materials. An embodiment of this type is illustrated in FIG. 3. As in the previous embodiments, Feedstocks A and B (and optionally Feedstocks C, D, etc.) can include any of the types of hydrocarbon feedstock materials listed herein but would be expected to exhibit some degree of mixing incompatibility, either between themselves, or with respect to the dispersed catalyst precursor blend, or both. The mixing system 300 illustrated in FIG. 3 can be a variation of the mixing system 100 of FIG. 1 or the mixing system 200 of FIG. 2, depending on the number of feedstocks being mixed.

As schematically illustrated in FIG. 3, the mixing system 300 illustrates an example configuration and corresponding method for combining a primary hydrocarbon feedstock material 302 (e.g., petroleum-derived), an alternate hydrocarbon feedstock material 306 (e.g., non-petroleum-derived), and a dispersed catalyst precursor 310 pre-mixed with a carrier oil 312 to form a diluted precursor mixture 316, which are mixed together to form hydrocarbon feedstock blends for subsequent processing. The mixing system 300 includes feedlines for each of the primary hydrocarbon feedstock material 302, the alternate hydrocarbon feedstock material 306, the dispersed catalyst precursor 310, and the carrier oil 312. In this embodiment, prior to being mixed with other hydrocarbon feedstock materials, the primary hydrocarbon feedstock material 302 can be optionally premixed by optional static inline mixer 304, and the alternate hydrocarbon feedstock material 306 can be optionally premixed by optional static inline mixer 308. Such pre-mixing may be beneficial in cases where the feedstock materials are a mixture of dissimilar materials and/or which are multi-phase so as to have liquid and solid components.

FIG. 3 further shows the dispersed catalyst precursor 310 and the carrier oil 312 being mixed by a static inline mixer 314 to form a diluted precursor mixture 316. This configuration is a catalyst precursor mixing module 318 that can be optionally added to any mixing system disclosed herein. The carrier oil can be petroleum-derived or non-petroleum-derived. Examples of petroleum-derived carrier oils include, but are not limited to, atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C. Examples of non-petroleum-derived carrier oils include, but are not limited to, biomass-derived materials, used cooking oil, plant-derived oils and fats, seed oils, animal-derived oils and fats, plastics and polymers, fabrics and textiles, paper and cardboard, rubber, waste products, and pyrolysis products of the foregoing (particularly in the case where the material is not a liquid at the processing temperature used to form the diluted precursor mixture 316).

The diluted precursor mixture 316 and the alternate hydrocarbon feedstock material 306 can be combined to form a partial feedstream 320, which is combined with the primary hydrocarbon feedstock material 302 to form a combined feedstream 322 prior to mixing. Although not shown, an optional static inline mixture can be used to premix the partial feedstream 320 to disperse the diluted precursor mixture 316 with the alternate hydrocarbon feedstock material 306. Alternatively, the diluted precursor mixture 316 can be premixed with the primary hydrocarbon feedstock material 302 to form a partial feedstream (not shown) prior to mixing with the alternate hydrocarbon feedstock material 306. Premixing the diluted precursor mixture 316 with the primary and/or alternate hydrocarbon feedstock materials 302, 306 can be beneficial to ensure more thorough mixing of the catalyst precursor 310 within the hydrocarbon feedstock blend 334.

The primary hydrocarbon feedstock material 302, the alternate hydrocarbon feedstock material 306, and the diluted precursor mixture 316 are combined into feedstream 322 prior to mixing. The combined feedstream 322 is initially mixed by one or more static inline mixers 324 to form an intermediate blend 326, which can be passed through optional strainer 328 to form optionally strained intermediate blend 330. The optionally strained intermediate blend 330 is then mixed by one or more high shear mixers 332 to form a well-mixed hydrocarbon feedstock blend 334. The well-mixed hydrocarbon feedstock blend 334 can be further processed by downstream processing system(s) 336. A portion of the well-mixed hydrocarbon feedstock blend 334 can optionally be recycled and combined with the primary hydrocarbon feedstock material 302, the alternate hydrocarbon feedstock material 306, and the diluted precursor mixture 316. Such recycling may be desirable to effect more complete mixing, particularly if the primary and alternate feedstock materials 302, 306 are particularly difficult to blend, to maintain desired flow rates in various parts of the system, to ensure even more thorough dispersion of the catalyst precursor 310 into the hydrocarbon feedstock blend 334, and the like.

An example method for mixing a plurality of dissimilar hydrocarbon feedstock materials, and optionally a dispersed catalyst precursor, to form a hydrocarbon feedstock blend for subsequent processing using the mixing system 300 illustrated in FIG. 3 comprises:
(1) providing a primary hydrocarbon feedstock material that consists of or comprises one or more petroleum-derived materials, and optionally one or more a non-petroleum-derived materials selected from the group consisting of biomass-derived material, non-petroleum-derived oil or fat, polymer, fabric or textile, paper or cardboard, rubber, waste product, pyrolysis product of one or more of the foregoing, and combinations thereof, and optionally pre-mixing the primary hydrocarbon feedstock by means of a static inline mixer;
(2) providing an alternate hydrocarbon feedstock material that differs from the first hydrocarbon feedstock material by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the second hydrocarbon feedstock by means of a static inline mixer;
(3) mixing a dispersed catalyst precursor with a carrier oil in one or more static inline mixers to form a diluted precursor mixture;
(4) optionally combining the diluted precursor mixture with the primary and/or alternate hydrocarbon feedstock materials to form a partial feedstream and premixing the partial feedstream by means of a static inline mixer;
(5) mixing the primary hydrocarbon feedstock material, the alternate hydrocarbon feedstock material, and the diluted precursor mixture by one or more static inline mixers to form an intermediate blend, and optionally straining the intermediate blend to form a strained intermediate blend; and
(6) further mixing the optionally straining intermediate blend by one or more high shear mixers to form the hydrocarbon feedstock blend, and optionally recycling a portion of the hydrocarbon feedstock blend by combining the recycled portion with the primary hydrocarbon feedstock material, alternate hydrocarbon feedstock material, and/or diluted precursor mixture.

In general, systems for mixing a plurality of dissimilar hydrocarbon feedstock materials to form a hydrocarbon feedstock blend for subsequent processing using the method illustrated associated with FIG. 3 comprise means (e.g., apparatus configured) for performing the steps recited in the preceding paragraph.

For any of the above process configurations, the high-shear mixer can be a commercially available high intensity mixing device, such as those supplied by Silverson Machines, Inc., located in Waterside, England, and IKA Works, Inc., located in Wilmington, North Carolina, United States. High shear mixers typically include a vessel with a propeller or turbine impeller for providing very turbulent, high shear mixing.

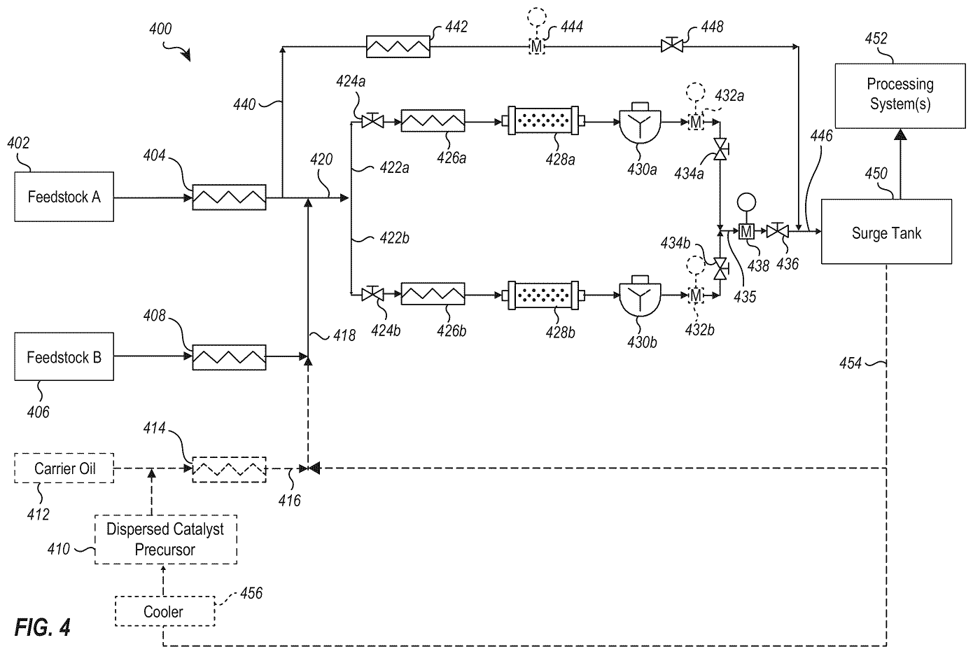

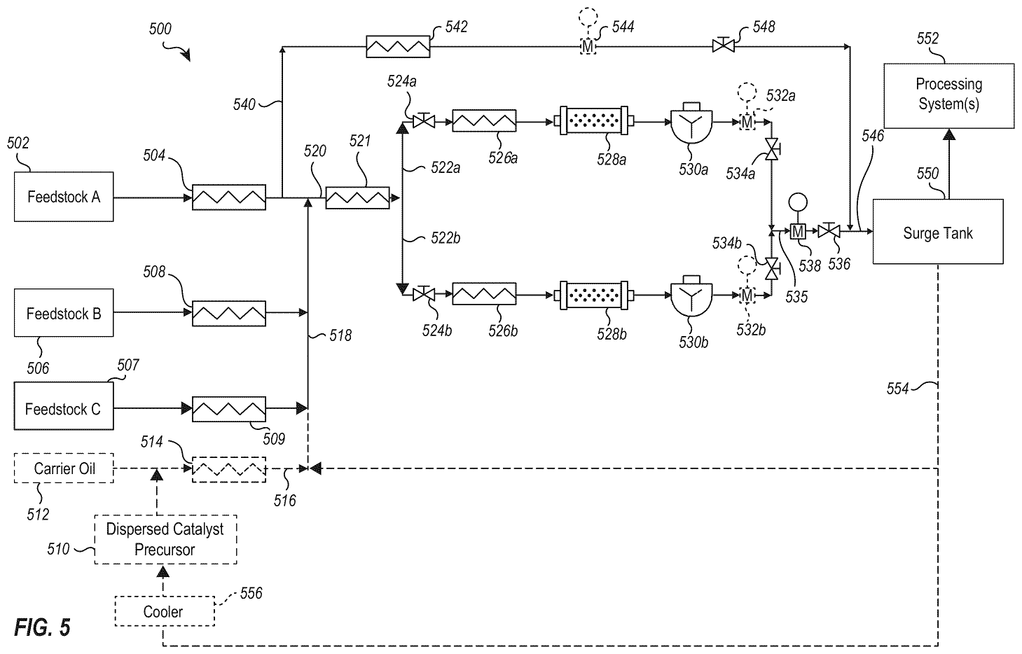

While FIGS. 1, 2 and 3 each show a mixing configuration with a single mixing line, this invention can also utilize mixing configurations disclosed in U.S. Pub. No. 2023/0383198, which is incorporated by reference in its entirety. FIGS. 4 and 5 schematically illustrate example mixing systems that incorporate a plurality of (e.g., two) mixing lines and a recirculation line in case a mixing line needs to be taken offline for maintenance.

FIG. 4 more particularly illustrates a mixing system 400 and corresponding method having two parallel mixing lines configured to mix together a plurality of (e.g., two) dissimilar hydrocarbon feedstock materials, and optionally a dispersed catalyst precursor, to form a hydrocarbon feedstock blend for subsequent processing. The mixing system 400 includes feedlines for each of a first hydrocarbon feedstock material 402 (arbitrarily designated as Feedstock A), a second hydrocarbon feedstock material 406 (arbitrarily designated as Feedstock B), an optional dispersed catalyst precursor 410, and an optional carrier oil 412. In this embodiment, prior to being mixed with other hydrocarbon feedstock materials, the first hydrocarbon feedstock material 402 can be optionally premixed by optional static inline mixer 404, and the second hydrocarbon feedstock material 406 can be optionally premixed by optional static inline mixer 408. Such pre-mixing may be beneficial in cases where the feedstock materials are a mixture of dissimilar materials and/or which are multi-phase so as to have liquid and solid components.

FIG. 4 further shows the optional dispersed catalyst precursor 410 and the optional carrier oil 412 being mixed by a static inline mixer 414 to form a diluted precursor mixture 416. The carrier oil 412 can be as discussed above relative to FIG. 3. The diluted precursor mixture 416 and the second hydrocarbon feedstock material 406 can be combined to form a partial feedstream 418, which is combined with the first hydrocarbon feedstock material 402 to form a combined feedstream 420 prior to mixing. Although not shown, an optional static inline mixture can be used to premix the partial feedstream 418 to disperse the diluted precursor mixture 416 with the second hydrocarbon feedstock material 406. Alternatively, the diluted precursor mixture 416 can be premixed with the first hydrocarbon feedstock material 402 to form a partial feedstream (not shown) prior to mixing with the second hydrocarbon feedstock material 406. Premixing the diluted precursor mixture 416 with the first and/or second hydrocarbon feedstock materials 402, 406 can be beneficial to ensure more thorough mixing of the catalyst precursor 410 within the hydrocarbon feedstock blend 446.

The first hydrocarbon feedstock material 402, the second hydrocarbon feedstock material 406, and the optional diluted precursor mixture 416 are combined into feedstream 420 prior to mixing. The combined feedstream 420 is split between first and second parallel mixing lines 422a, 422b. Each mixing line 422a, 422b may include an upstream valve 424a, 424b, which can be selectively opened during operation of the mixing lines 422a, 422b and closed to take a mixing line 422 offline (e.g., for maintenance and cleaning). When the first and second parallel mixing lines 422a, 422b are both online, the upstream valves 424a, 424b are open to permit the divided streams of the combined feedstream 420 to flow through the first and second mixing lines 422a, 422b. One of the upstream valves 424a, 424b can be closed to take one of the mixing lines 422a, 422b offline. In a preferred embodiment, the first and second parallel mixing lines 422a, 422b are designed with symmetrical piping and mixing equipment so that the pressure drop is substantially equal through each parallel mixing line 422a, 422b, and equal flow between the mixing lines 422a, 422b can be maintained. Nevertheless, mixing lines 422 of different capacity and flow can be used, such as when retrofitting a single train mixing line to include one or more additional mixing lines. It will be appreciated that one or more additional mixing lines (not shown) can be utilized if desired to further increase the capacity of the mixing system 400.

The divided streams of the combined feedstream 420 are initially mixed by first and second static inline mixers 426a, 426b to produce first and second initial mixed streams, which can pass through optional first and second strainers 428a, 428b to remove any undesirable solids in the initial mixed streams. The first and second optionally strained mixed streams are further mixed by first and second high shear mixers 430a, 430b, which provide first and second blended hydrocarbon feedstock streams. Optional first and second flow meters 432a, 432b can be provided to measure flow through the first and second mixing lines 422a, 422b downstream from the first and second high shear mixers 430a, 430b.

The first and second parallel mixing lines 422a, 422b further include first and second flow control devices 434a, 434b positioned downstream from the high shear mixers 430a, 430b, respectively. The flow control devices 434a, 434b can provide multiple functions. When the first and second parallel mixing lines 422a, 422b are both online, the flow control devices 434a, 434b will be open. When one of the mixing lines 422 is taken offline, the corresponding flow control device 434 can be closed to prevent backup of pressurized blended feedstock from the other mixing line 422 still in operation. The flow control device 434 of the mixing line 422 that is still in operation can be open all the way or, alternatively, can be partially closed if necessary to restrict flow and increase upstream pressure to cause or allow a portion of the combined feedstream 420 to enter a bypass line 440.

The blended hydrocarbon feedstock streams from the first and second mixing lines 422a, 422b are fed into and combined in a common discharge line 435 to form a common blended hydrocarbon feedstock stream 446. The common blended hydrocarbon feedstock stream 446 passes through or past a common flow measurement device 438 (e.g., flow meter) and then through a common flow control device 436 (e.g., valve), is recombined with any hydrocarbon feedstock material from the bypass line 440, and enters a surge tank 450 to form a well-mixed hydrocarbon feedstock blend for subsequent processing. The well-mixed hydrocarbon feedstock blend can be further processed by downstream processing system(s) 452.

A side stream 454 of the hydrocarbon feedstock blend from the surge tank 450 can optionally be recycled, such as by being added to the partial feedstream 418 and/or by providing all or a portion of the carrier oil 412 used to form the diluted precursor mixture 416. When used as the carrier oil 412, a cooler 456 can be used to reduce the temperature of the side stream 454 of the hydrocarbon feedstock blend to prevent premature thermal decomposition of the catalyst precursor 410 in the diluted precursor mixture 416 prior to being thoroughly mixed with the first and second hydrocarbon feedstock materials 402, 406. When used as all or part of the carrier oil 412, the side stream 454 of the hydrocarbon feedstock blend can be cooled to a temperature of about 75° C. to about 150° C., preferably about 75° C. to about 125° C., and more preferably about 75° C. to about 95° C. In some embodiments, at least a portion of the cooling can be provided by a lower boiling hydrocarbon carrier oil 412 (e.g., vacuum gas oil or cycle oil) that is already at a temperature below the decomposition temperature of the catalyst precursor 410.

When both parallel mixing lines 422a, 422b are online and operational, the common flow control device 436 is open. When one of the mixing lines 422a, 422b is closed and taken offline, such as by closing one or more flow control valves 422, 434, the common flow control device 436 can be partially closed to restrict flow of material through the common discharge line 435 and increase upstream pressure to cause or allow a portion of the combined feedstream 420 and/or one of the first and second hydrocarbon feedstock materials 402, 406 to enter the bypass line 440. The common flow control device 436 can be used alone or in combination with one of the flow control devices 434 corresponding to the mixing line 422 that is still in operation to control upstream pressure.

The bypass line 440 typically does not have hydrocarbon feedstock material flowing through it when both the first and second mixing lines 422a, 422b are online and in operation. However, when one of the parallel mixing lines 422a, 422b is closed and taken offline, the portion of hydrocarbon feedstock material not fed into the remaining online mixing line 422 is caused or allowed to pass through the bypass line 440 to maintain throughput of hydrocarbon feedstock materials through the mixing system 400. As discussed above, flow of hydrocarbon feedstock material though the bypass line 440 is caused or induced by restricting flow through the common discharge line 435 by partially closing common flow control valve 436 and/or the mixing line valve 434 of the operational mixing line 422. This induces a pressure drop and increases upstream pressure sufficient to cause a portion of hydrocarbon feedstock material to enter the bypass line 440.

The bypass line 440 can include an optional static inline mixer 442 to cause at least partial mixing of dissimilar hydrocarbon feedstock materials 402, 406 and the optional diluted precursor mixture 416 that may enter the bypass line 440. The bypass line 440 can include an optional flow meter 444 to measure the flow rate of hydrocarbon feedstock material passing through the bypass line 440. The bypass line 440 can include a bypass line valve 448 to control the flow rate and/or pressure of hydrocarbon feedstock material passing through the bypass line 440. The bypass line 440 is joined to the common discharge line 435 to combine hydrocarbon feedstock material from the bypass line 440 with the common blended hydrocarbon feedstock stream 446 downstream from the flow control device 436 and flow meter 438.

The flow rates of hydrocarbon feedstock streams that are passed through the remaining operational mixing line 422 and the bypass line 440 can be measured, respectively, by the common flow meter 438 and the optional bypass flow meter 444. The respective flow rates of hydrocarbon feedstock material through the remaining operational mixing line 422 and the bypass line 440 can be adjusted by making adjustments to the common flow control valve 436 and/or the bypass line valve 448. By measuring flow rates using flow meters and making adjustments using flow control devices, a desired balance of flow through the various lines can be achieved and maintained. In addition to adjusting flow rate through the bypass line 440, the bypass line valve 448 can be closed or partially restricted to balance line pressure to ensure that hydrocarbon feedstock material does not pass through the bypass line 440, either in a forward or backward direction, when the first and second mixing lines 422a, 422b are open and operational.

An example method for mixing dissimilar hydrocarbon feedstock materials, and optionally a dispersed catalyst precursor, to form a hydrocarbon feedstock blend for subsequent processing using the mixing system 400 illustrated in FIG. 4 comprises:
(1) providing a first hydrocarbon feedstock material selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the first hydrocarbon feedstock by a static inline mixer;
(2) providing a second hydrocarbon feedstock material that differs from the first hydrocarbon feedstock material by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the second hydrocarbon feedstock by a static inline mixer;
(3) optionally mixing a dispersed catalyst precursor with a carrier oil in one or more static inline mixers to form an optional diluted precursor mixture and combining the optional diluted precursor mixture with the first and second hydrocarbon feedstock materials;
(4) mixing the first hydrocarbon feedstock material, the second hydrocarbon feedstock material, and the optional diluted precursor mixture using a plurality of parallel mixing lines to form a plurality of blended hydrocarbon feedstock streams, each parallel mixing line including one or more static inline mixers, optionally a strainer, one or more high shear mixers, and at least one valve for regulating flow in the mixing line;
(5) combining the blended hydrocarbon feedstock streams in a common discharge line downstream from the parallel mixing lines to form a blended hydrocarbon feedstock;
(6) stopping flow through a mixing line and causing or allowing a portion of hydrocarbon feedstock material to enter a bypass line, bypass the parallel mixing lines, and combine with the blended hydrocarbon feedstock in the common discharge line;
(7) while the portion of the hydrocarbon feedstock material is passing through the bypass line, continuing to mix the first and second hydrocarbon feedstock materials and the optional diluted precursor mixture using at least one other of the parallel mixing lines to form the hydrocarbon feedstock blend; and
(8) optionally recycling a portion of the hydrocarbon feedstock blend by combining the recycled portion with the first hydrocarbon feedstock material, the second hydrocarbon feedstock material, and/or the optional diluted precursor mixture.

In general, systems for mixing a plurality of dissimilar hydrocarbon feedstock materials to form a hydrocarbon feedstock blend for subsequent processing using the method illustrated associated with FIG. 4 comprise means (e.g., apparatus configured) for performing the steps recited in the preceding paragraph.

FIG. 5 schematically illustrates another example mixing system 500 that incorporates a plurality of (e.g., two) mixing lines and a recirculation line in case a mixing line needs to be taken offline for maintenance. The main difference between the mixing system 500 of FIG. 5 and the mixing system 400 of FIG. 4 is the mixing of at least one additional hydrocarbon feedstock material and the incorporation of a static inline mixer before dividing the common feedstock stream into multiple streams to be mixed by the plurality of mixing lines. This helps ensure more thorough mixing of the multiple hydrocarbon feedstock materials and optional diluted precursor mixture prior to being divided between the different mixing lines.

FIG. 5 more particularly illustrates a mixing system 500 and corresponding method having two mixing lines configured to mix together a plurality of (e.g., three) dissimilar hydrocarbon feedstock materials, and optionally a dispersed catalyst precursor, to form a hydrocarbon feedstock blend for subsequent processing. The mixing system 500 includes feedlines for each of a first hydrocarbon feedstock material 502 (arbitrarily designated as Feedstock A), a second hydrocarbon feedstock material 506 (arbitrarily designated as Feedstock B), a third hydrocarbon feedstock material 507 (arbitrarily designated as Feedstock C), an optional dispersed catalyst precursor 510, and an optional carrier oil 512. In this embodiment, prior to being mixed with other hydrocarbon feedstock materials, the first hydrocarbon feedstock material 502 can be optionally premixed by optional static inline mixer 504, the second hydrocarbon feedstock material 506 can be optionally premixed by optional static inline mixer 508, and the third hydrocarbon feedstock material 507 can be optionally premixed by optional static inline mixer 509. Such pre-mixing may be beneficial in cases where the feedstock materials are a mixture of dissimilar materials and/or which are multi-phase so as to have liquid and solid components.

FIG. 5 further shows the optional dispersed catalyst precursor 510 and the optional carrier oil 512 being mixed by a static inline mixer 514 to form a diluted precursor mixture 516. The carrier oil can be as discussed above relative to FIG. 3. The diluted precursor mixture 516, the second hydrocarbon feedstock material 506, and the third hydrocarbon feedstock material 507 can be combined to form a partial feedstream 518, which is combined with the first hydrocarbon feedstock material 502 to form a combined feedstream 520 prior to mixing. Although not shown, an optional static inline mixture can be used to premix the partial feedstream 518 to disperse the diluted precursor mixture 516 with the second and third hydrocarbon feedstock materials 506, 507. Alternatively, the diluted precursor mixture 516 can be premixed with the first hydrocarbon feedstock material 502 to form a partial feedstream (not shown) prior to mixing with the second and third hydrocarbon feedstock materials 506, 507. Premixing the diluted precursor mixture 516 with the first, second, and/or third hydrocarbon feedstock materials 502, 506, 507 can be beneficial to ensure more thorough mixing of the catalyst precursor 510 within the blended hydrocarbon feedstock 546.

The first hydrocarbon feedstock material 502, the second hydrocarbon feedstock material 506, the third hydrocarbon feedstock material 507, and the optional diluted precursor mixture 516 are combined into combined feedstream 520, which is pre-mixed in a common static inline mixer 521 prior to entering the parallel mixing lines. Such pre-mixing of the combined feedstream 520 ensures more even distribution of dissimilar hydrocarbon feedstock materials and optional catalyst precursor prior to being split between first and second parallel mixing lines 522a, 522b.

The combined and pre-mixed feedstream 520 is split between first and second parallel mixing lines 522a, 522b. Each mixing line 522a, 522b may include an upstream valve 524a, 524b, which can be selectively opened during operation of the mixing lines 522a, 522b and closed to take a mixing line 522 offline (e.g., for maintenance and cleaning). When the first and second parallel mixing lines 522a, 522b are both online, the upstream valves 524a, 524b are open to permit the divided streams of the combined feedstream 520 to flow through the first and second mixing lines 522a, 522b. In a preferred embodiment, the first and second parallel mixing lines 522a, 522b are designed with symmetrical piping and mixing equipment so that the pressure drop is substantially equal through each parallel mixing line 522a, 522b and equal flow between the mixing lines 522a, 522b can be maintained. Nevertheless, mixing lines 522 of different capacity and flow can be used, such as when retrofitting a single train mixing line to include one or more additional mixing lines. It will be appreciated that one or more additional mixing lines (not shown) can be utilized if desired to further increase the capacity of the mixing system 500.

The divided streams of the combined feedstream 520 are initially mixed by first and second static inline mixers 526a, 526b to produce first and second initial mixed streams, which can pass through optional first and second strainers 528a, 528b to remove any undesirable solids in the initial mixed streams. The first and second optionally strained mixed streams are further mixed by first and second high shear mixers 530a, 530b, which provide first and second blended hydrocarbon feedstock streams. Optional first and second flow meters 532a, 532b can be provided to measure flow through the first and second mixing lines 522a, 522b downstream from the first and second high shear mixers 530a, 530b.

The first and second parallel mixing lines 522a, 522b further include first and second flow control devices 534a, 534b positioned downstream from the high shear mixers 530a, 530b, respectively. The flow control devices 534a, 534b can provide multiple functions. When the first and second parallel mixing lines 522a, 522b are both online, the flow control devices 534a, 534b will be open. When one of the mixing lines 522 is taken offline, the corresponding flow control device 534 can be closed to prevent backup of pressurized blended feedstock from the other mixing line 522 still in operation. The flow control device 534 of the mixing line 522 that is still in operation can be open all the way or, alternatively, can be partially closed if necessary to restrict flow and increase upstream pressure to cause or allow a portion of the combined feedstream 520 to enter a bypass line 540.

The blended hydrocarbon feedstock streams from the first and second mixing lines 522a, 522b are fed into and combined in a common discharge line 535 to form a common blended hydrocarbon feedstock stream 546. The common blended hydrocarbon feedstock stream 546 passes through or past a common flow measurement device 538 (e.g., flow meter) and then through a common flow control device 536 (e.g., valve), is recombined with any hydrocarbon feedstock material from the bypass line 540, and enters a surge tank 550 to form a well-mixed hydrocarbon feedstock blend for subsequent processing. The well-mixed hydrocarbon feedstock blend can be further processed by downstream processing system(s) 552.

A side stream 554 of the hydrocarbon feedstock blend from the surge tank 550 can optionally be recycled, such as by being added to the partial feedstream 518 and/or providing all or a portion of the carrier oil 512 used to make the diluted precursor mixture 516. When used as the carrier oil 512, a cooler 556 can be used to reduce the temperature of the side stream 554 of the hydrocarbon feedstock blend to prevent premature thermal decomposition of the catalyst precursor 510 in the diluted precursor mixture 516 prior to being thoroughly mixed with the first, second, and third hydrocarbon feedstock materials 502, 506, 507. When used as the carrier oil 512, the side stream 554 of the hydrocarbon feedstock blend can be cooled to a temperature of about 75° C. to about 150° C., preferably about 75° C. to about 125° C., and more preferably about 75° C. to about 95° C. In some embodiments, at least a portion of the cooling can be provided by a lower boiling hydrocarbon carrier oil 512 (e.g., vacuum gas oil or cycle oil) that is already at a temperature below the decomposition temperature of the catalyst precursor.

When both parallel mixing lines 522a, 522b are online and operational, the common flow control device 536 is open. When one of the mixing lines 522a, 522b is closed and taken offline, the common flow control device 536 can be partially closed to restrict flow of material through the common discharge line 535 and increase upstream pressure to cause or allow a portion of the combined feedstream 520 and/or one of the first, second, and third hydrocarbon feedstock materials 502, 506, 507 to enter the bypass line 540. The common flow control device 536 can be used alone or in combination with one of the flow control devices 534 corresponding to the mixing line 522 that is still in operation to control upstream pressure.

The bypass line 540 typically does not have hydrocarbon feedstock material flowing through it when both the first and second mixing lines 522a, 522b are online and in operation. However, when one of the parallel mixing lines 522 is closed and taken offline, the portion of hydrocarbon feedstock material not fed into the remaining online mixing line 522 is caused or allowed to pass through the bypass line 540 to maintain throughput of hydrocarbon feedstock materials through the mixing system 500. As discussed above, flow of hydrocarbon feedstock material though the bypass line 540 is caused or induced by restricting flow through the common discharge line 535 by partially closing common flow control valve 536 and/or the mixing line valve 534 of the operational mixing line 522. This induces a pressure drop and increases upstream pressure sufficient to cause a portion of hydrocarbon feedstock material to enter the bypass line 540.

The bypass line 540 can include an optional static inline mixer 542 to cause at least partial mixing of dissimilar hydrocarbon feedstock materials 502, 506, 507 and the optional diluted precursor mixture 516 that may enter the bypass line 540. The bypass line 540 can include an optional flow meter 544 to measure the flow rate of hydrocarbon feedstock material passing through the bypass line 540. The bypass line 540 can include a bypass line valve 548 to control the flow rate and/or pressure of hydrocarbon feedstock material passing through the bypass line 540. The bypass line 540 is joined to the common discharge line 535 to combine hydrocarbon feedstock material from the bypass line 540 with the common blended hydrocarbon feedstock stream 546 downstream from the flow control device 536 and flow meter 538.

The flow rates of hydrocarbon feedstock streams that are passed through the remaining operational mixing line 522 and the bypass line 540 can be measured, respectively, by the common flow meter 538 and the optional bypass flow meter 544. The respective flow rates of hydrocarbon feedstock material through the remaining operational mixing line 522 and the bypass line 540 can be adjusted by making adjustments to the common flow control valve 536 and/or the bypass line valve 548. By measuring flow rates using flow meters and making adjustments using flow control devices, a desired balance of flow through the various lines can be achieved and maintained. In addition to adjusting flow rate through the bypass line 540, the bypass line valve 548 can be closed or partially restricted to balance line pressure to ensure that hydrocarbon feedstock material does not pass through the bypass line 540, either in a forward or backward direction, when the first and second mixing lines 522a, 522b are open and operational.

An example method for mixing dissimilar hydrocarbon feedstock materials, and optionally a dispersed catalyst precursor, to form a hydrocarbon feedstock blend for subsequent processing using the mixing system 500 illustrated in FIG. 5 comprises:
(1) providing a first hydrocarbon feedstock material selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the first hydrocarbon feedstock by a static inline mixer;
(2) providing a second hydrocarbon feedstock material that differs from the first hydrocarbon feedstock material by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the second hydrocarbon feedstock by a static inline mixer;
(3) providing a third hydrocarbon feedstock material that differs from the first hydrocarbon feedstock material and the second hydrocarbon feedstock material by at least one of chemical composition, polarity, solubility, or physical state, wherein the third hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof, and optionally pre-mixing the third hydrocarbon feedstock by a static inline mixer;
(4) optionally mixing a dispersed catalyst precursor with a carrier oil in one or more static inline mixers to form an optional diluted precursor mixture and combining the optional diluted precursor mixture with the first, second, and third hydrocarbon feedstock materials;
(5) combining the first, second, and third hydrocarbon feedstock materials, and the optional diluted precursor mixture, to form a combined feedstream, and pre-mixing the combined feedstream in one or more static inline mixers;
(6) dividing the combined and pre-mixed feedstock material into parallel hydrocarbon streams and mixing the parallel hydrocarbon streams using a plurality of parallel mixing lines to form a plurality of blended hydrocarbon feedstock streams, each parallel mixing line including one or more static inline mixers, optionally a strainer, one or more high shear mixers, and at least one valve for regulating flow in the mixing line;
(7) combining the blended hydrocarbon feedstock streams in a common discharge line downstream from the parallel mixing lines to form a hydrocarbon feedstock blend;
(8) stopping flow through a mixing line and causing or allowing a portion of hydrocarbon feedstock material to enter a bypass line, bypass the parallel mixing lines, and combine with the hydrocarbon feedstock blend in the common discharge line;
(9) while the portion of the hydrocarbon feedstock material is passing through the bypass line, continuing to mix the first and second hydrocarbon feedstock materials and the optional diluted precursor mixture using at least one other of the parallel mixing lines to form the hydrocarbon feedstock blend; and
(10) optionally recycling a portion of the hydrocarbon feedstock blend by combining the recycled portion with the first hydrocarbon feedstock material, the second hydrocarbon feedstock material, and/or the optional diluted precursor mixture.

In general, systems for mixing a plurality of dissimilar hydrocarbon feedstock materials to form a hydrocarbon feedstock blend for subsequent processing using the method illustrated associated with FIG. 5 comprise means (e.g., apparatus configured) for performing the steps recited in the preceding paragraph.

The systems and methods discussed above relative to FIGS. 1-5 can be used to blend a variety of dissimilar hydrocarbon feedstock materials. In the case where one or more petroleum-derived materials are mixed with one or more non-petroleum-derived materials, the hydrocarbon feedstock blend may comprise at least about 1%, 3%, 5%, 10%, 15%, 20%, 30%, 40%, or 50% and less than about 99%, 97%, 95%, 90%, 85%, 80%, 70%, 60%, or 50%, by weight of the one or more petroleum-derived materials (or in a range defined by any two of the foregoing values) and at least about 1%, 3%, 5%, 10%, 15%, 20%, 30%, 40%, or 50% and less than about 99%, 97%, 95%, 90%, 85%, 80%, 70%, 60%, or 50%, by weight of the one or more non-petroleum-derived materials (or in a range defined by any two of the foregoing values).

In some embodiments, such as where one or more non-petroleum-derived materials are solid at the temperature at which they are mixed with one or more other hydrocarbon feedstock materials, it can be advantageous to liquify and/or comminute any initially solid hydrocarbon feedstock materials to a particle size of about 50 mesh (about 300 μm) or smaller, or about 70 mesh (about 210 μm) or smaller, or about 100 mesh (about 150 μm) or smaller.

For any of the systems and methods discussed above relative to FIGS. 1-5, the duration of mixing within the one or more static inline mixers in a mixing station can be in a range of about 0.1 second to about 5 minutes, or in a range of about 0.5 second to about 1 minute, or in a range of about 1 second to about 10 seconds, and the duration of mixing within the one or more high shear mixers in a mixing station can be in a range of about 0.1 second to about 5 minutes, or in a range of about 0.5 second to about 3 minutes, or in a range of about 1 second to about 1 minute.

The degree of mixing achieved within the static inline mixers is dependent, at least in part, on the number of stages. In some embodiments, static inline mixers may include 2 to 20 stages, preferably 7 to 15 stages, and more preferably 8 to 12 stages. In mixing theory, each “stage” is substantially equivalent to having a vessel that is vigorously stirred. Because mixing is imperfect (i.e., there is some short circuiting of the vessel by the components to be mixed), the degree of mixing is improved if a series of mixing vessels (i.e., stages) are used. An exemplary static inline mixer includes no moving parts but a plurality of internal baffles or other elements inside a tube or other housing. The internal baffles or other elements channel the flowing fluid in many different directions by repeatedly dividing and recombining the fluid in a turbulent manner so as to mix the various components. The number of stages in a static inline mixer empirically correlates to the degree of mixing that can be expected within the static mixer when compared to the degree of mixing that would occur if using a series of mixing vessels (i.e., the fluid leaving the first vessel enters the second vessel for mixing, the fluid leaving the second vessel enters the third vessel, and so on). In other words, a static inline mixer characterized as including 10 stages provides a degree of mixing that is substantially equivalent to that provided by a mixing system comprising a series of 10 mixing vessels.

The dissimilar hydrocarbon feedstock materials are advantageously mixed at a temperature in a range of about 40° C. (104° F.) to about 350° C. (662° F.), or in a range of about 60° C. (140° F.) to about 300° C. (572° F.), or in a range of about 75° C. (167° F.) to about 250° C. (482° F.) to yield a well-mixed hydrocarbon feedstock blend.

When included, the optional catalyst precursor is advantageously mixed with the optional carrier oil below a temperature at which a significant portion of the catalyst precursor decomposes. The mixing may be performed at temperature in a range of about 40° C. (104° F.) to about 250° C. (482° F.), or in range of about 60° C. (140° F.) to about 200° C. (392° F.), or in a range of about 75° C. (167° F.) to about 125° C. (257° F.), to form the diluted precursor mixture. The temperature at which the diluted precursor mixture is formed may depend on the decomposition temperature and/or other characteristics of the catalyst precursor that is utilized and/or characteristics of the hydrocarbon carrier oil, such as viscosity. The carrier oil can be used in amounts ranging from 0.1% to 10%, or about 0.5% to about 5%, by volume of the total hydrocarbon feedstock blend.

Because the optional catalyst precursor is premixed with the carrier oil to form a diluted precursor mixture, which is thereafter mixed with the dissimilar hydrocarbon feedstock materials, it may be permissible for the hydrocarbon feedstock materials to be at or above the decomposition temperature of the catalyst precursor. In some cases, the carrier oil shields the individual catalyst precursor molecules and prevents them from agglomerating to form larger particles, temporarily insulates the catalyst precursor molecules from heat from the hydrocarbon feedstock materials during mixing, and facilitates dispersion of the catalyst precursor molecules sufficiently quickly throughout the hydrocarbon feedstock materials before decomposing to liberate metal and form dispersed metal sulfide catalyst particles. In addition, additional heating of the hydrocarbon feedstock blend may be necessary to liberate hydrogen sulfide from sulfur-bearing molecules in the hydrocarbon feedstock blend to form the dispersed metal sulfide catalyst particles. In this way, progressive dilution of the catalyst precursor permits a high level of dispersion within the hydrocarbon feedstock blend, resulting in the formation of highly dispersed metal sulfide catalyst particles in situ, even where the feedstock is at a temperature above the decomposition temperature of the catalyst precursor. In some cases, a source of sulfur-bearing hydrocarbons can be added to sulfur-deficient hydrocarbon feedstock materials in order to form the dispersed metal sulfide catalyst particles. Metal from the catalyst precursor may initially form a metal oxide, which then reacts with sulfur in the hydrocarbon feedstock blend to yield a metal sulfide compound that forms the final active catalyst.

Diluting the catalyst precursor with a hydrocarbon carrier prior to mixing with the hydrocarbon feedstock material is helpful in achieving thorough blending of the precursor within the hydrocarbon feedstock material because the hydrocarbon oil diluent is more easily blended with the hydrocarbon feedstock material than the catalyst precursor by itself. It is important that the catalyst precursor be pre-mixed with the hydrocarbon carrier oil and that care be taken in the overall method and mixing system to mix the components for a time sufficient to thoroughly blend the precursor with the hydrocarbon feedstock material before substantial decomposition of the precursor has occurred.

Additional apparatus may be included downstream from the mixing systems illustrated in FIGS. 1-5 for providing additional mixing of the dissimilar hydrocarbon feedstock materials and to better disperse the optional catalyst precursor. For example, the mixing lines shown in FIGS. 1-3 can be followed by a surge tank, such as the surge tanks 450, 550 shown in FIGS. 4 and 5, respectively, with recirculation pump(s), and optionally one or more multi-stage centrifugal pumps and a second surge tank (not shown). Further mixing can be carried out using a high energy pump having multiple chambers (not shown) within which the dissimilar hydrocarbon feedstock materials and optional catalyst precursor are churned and mixed as part of the pumping process itself used to deliver the hydrocarbon feedstock blend to downstream processing equipment (e.g., a hydroprocessing reactor).

In some embodiments, pumps may be situated so as to be in series or a combination of series and parallel pumps. Placing pumps in series effectively increases the number of intense mixing stages through which the hydrocarbon feedstock blend passes. For example, two pumps in series each including five stages could be used instead of a single pump including ten stages to achieve substantially the same intimate mixing of the dissimilar hydrocarbon feedstock materials to yield the hydrocarbon feedstock blend.

After the catalyst precursor has been well-mixed throughout the hydrocarbon feedstock material to yield a conditioned feedstock, this composition is heated to cause decomposition of the catalyst precursor, which liberates catalyst metal therefrom, causes or allows catalyst metal to react with sulfur within and/or added to the hydrocarbon feedstock material, and forms the active metal sulfide catalyst particles in situ. Metal from the catalyst precursor may initially form a metal oxide, which then reacts with sulfur in the hydrocarbon feedstock material to yield a metal sulfide compound that forms the final active catalyst. In the case where the hydrocarbon feedstock material includes sufficient or excess sulfur, the final activated catalyst may be formed in situ by heating the feedstock to a temperature sufficient to liberate sulfur therefrom. In some cases, sulfur may be liberated at the same temperature that the catalyst precursor decomposes. In other cases, further heating to a higher temperature may be required. Hydrogen sulfide gas can be added to hydrocarbon feedstock material that lacks sufficient sulfur to form active metal sulfide catalyst particles.

If the catalyst precursor is thoroughly mixed throughout the hydrocarbon feedstock blend, at least a substantial portion of the liberated metal ions will be sufficiently sheltered or shielded from other metal ions so that they can form a molecularly dispersed catalyst upon reacting with sulfur to form the metal sulfide compound. Under some circumstances, minor agglomeration may occur, yielding colloidal-sized catalyst particles. However, it is believed that taking care to thoroughly mix the catalyst precursor throughout the hydrocarbon feedstock blend prior to thermal decomposition of the catalyst precursor may yield individual catalyst molecules rather than colloidal particles. Simply blending, while failing to sufficiently mix, the catalyst precursor with the hydrocarbon feedstock blend typically causes formation of large, agglomerated metal sulfide compounds that are micron-sized or larger.

In order to form dispersed metal sulfide catalyst particles, the conditioned feedstock is heated to a temperature in a range of about 275° C. (527° F.) to about 450° C. (842° F.), or in a range of about 310° C. (590° F.) to about 430° C. (806° F.), or in a range of about 330° C. (626° F.) to about 410° C. (770° F.).

The concentration of catalyst metal provided by the dispersed metal sulfide catalyst particles in the hydrocarbon feedstock blend can depend on the type of reactor being employed. In the case where the dispersed metal sulfide catalyst is used together with a solid supported catalyst (e.g., ebullated bed reactor or fixed bed reactor), the concentration can be in a range of about 1 ppm to about 150 ppm by weight, or in a range of about 5 ppm to about 95 ppm by weight, or in a range of about 10 ppm to about 75 ppm by weight, of the hydrocarbon feedstock blend. In the case where the dispersed metal sulfide catalyst is the only catalyst being employed (e.g., slurry reactor), the concentration will typically be higher, such as in a range of about 30 ppm to about 1000 ppm by weight, or in a range of about 50 ppm to about 500 ppm by weight, or in a range of about 75 ppm to about 300 ppm by weight, of the hydrocarbon feedstock blend.

In the case where the hydrocarbon feedstock blend includes asphaltene molecules, the dispersed metal sulfide catalyst particles may preferentially associate with or remain in close proximity to the asphaltene molecules. Asphaltene molecules can have a greater affinity for the metal sulfide catalyst particles since asphaltene molecules are generally more hydrophilic and less hydrophobic than other hydrocarbons contained in heavy oil, when included in the hydrocarbon feedstock blend. Because metal sulfide catalyst particles tend to be hydrophilic, the individual particles or molecules will tend to migrate toward more hydrophilic moieties or molecules within heavy oil.

The hydrocarbon feedstock blends formed according to the systems and methods disclosed herein, including relative to FIGS. 1-5 discussed above, can be processed by processing methods and systems known in the art, including one or more of hydrocracking or hydroconversion (e.g., by an ebullated bed, fixed bed, or slurry bed) solvent deasphalting, coking (delayed coking and/or Flexicoking), fluid catalytic cracking, hydroprocessing, or hydrotreating.

Systems for blending a plurality of dissimilar hydrocarbon feedstock materials to form a hydrocarbon feedstock blend for subsequent processing comprise means for performing the method steps disclosed herein. In addition to supply lines and mixers, such as the static-inline mixers and high shear mixers discussed herein, the system may further comprise processing equipment selected from the group consisting of strainers, filters, pumps, furnaces, heat exchangers, reactors, separators, tanks, and distillation columns.

### V. EXAMPLES

### Example 1—Mixing of Plastic-Derived Feedstock and Petroleum-Derived Feedstock

A mixing system is configured according to the embodiment illustrated in FIG. 1 or FIG. 4 and designed to process a total feed rate of 250 metric tonnes per hour (mt/hr). Feedstock A is straight-run vacuum residue derived from distillation of Middle Eastern crude oil and is fed at a rate of 125 mt/hr and a temperature of 150° C. Feedstock B is a pyrolysis oil derived from mixed plastics and is fed at a rate of 125 mt/hr and a temperature of 150° C. These dissimilar hydrocarbon feedstock materials are ordinarily incompatible, such that it would not be possible to create a stable, combined feedstock blend that can be processed using downstream equipment.

For Feedstock A, the optional static inline mixer shown in FIG. 1 or FIG. 4 is omitted, but the optional static inline mixer is included for Feedstock B. After combining the two dissimilar hydrocarbon feedstock materials, the initial hydrocarbon feedstock mixture is passed through a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstock materials. The resulting hydrocarbon feedstock blend is now sufficiently stable and uniformly blended for processing in downstream equipment.

### Example 2—Mixing of Bio-Derived Feedstock and Petroleum-Derived Feedstock

A mixing system is configured according to the embodiment illustrated in FIG. 1 or FIG. 4 and designed to process a total feed rate of 250 mt/hr. Feedstock A is straight-run vacuum gas oil (VGO) derived from distillation of Middle Eastern crude oil and is fed at a rate of 125 mt/hr and a temperature of 100° C. Feedstock B is a pyrolysis oil derived from biomass (plant matter) and is fed at a rate of 125 mt/hr and a temperature of 110° C. These dissimilar hydrocarbon feedstock materials are ordinarily incompatible, such that it would not be possible to create a stable, combined feedstock blend that can be processed using downstream equipment.

For Feedstock A, the optional static inline mixer shown in FIG. 1 or FIG. 4 is omitted, but the optional static inline mixer is included for Feedstock B. After combining the two dissimilar hydrocarbon feedstock materials, the initial hydrocarbon feedstock mixture is passed through a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstock materials. The resulting hydrocarbon feedstock blend is now sufficiently stable and uniformly blended for processing in downstream equipment.

### Example 3—Mixing of Plastic-Derived Feedstock, Bio-Derived Feedstock, and Petroleum-Derived Feedstock

A mixing system is configured according to the embodiment illustrated in FIG. 2 or FIG. 5 and designed to process a total feed rate of 250 mt/hr. Feedstock A is straight-run atmospheric residue (350° C. cut point) derived from distillation of Canadian crude oil such as Cold Lake and is fed at a rate of 125 mt/hr and a temperature of 100° C. Feedstock B is a pyrolysis oil derived from mixed plastics and is fed at a rate of 62.5 mt/hr and a temperature of 110° C. Feedstock C is a pyrolysis oil derived from biomass (plant matter) and is fed at a rate of 62.5 mt/hr and a temperature of 110° C. These dissimilar hydrocarbon feedstock materials are ordinarily incompatible, such that it would not be possible to create a stable, combined feedstock blend that can be processed using downstream equipment.

For Feedstock A, the optional static inline mixer shown in FIG. 2 or FIG. 5 is omitted, but the optional static inline mixers are included for Feedstock B and Feedstock C. After combining Feedstocks B and C, they are initially pre-mixed in the additional optional static inline mixer. The pre-mixed hydrocarbon stream of Feedstocks B and C are then combined with Feedstock A, and the resulting combined feedstock mixture is further mixed by a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstock materials. The resulting hydrocarbon feedstock blend is now sufficiently stable and uniformly blended for processing in downstream equipment.

### Example 4—Mixing of Rubber Tire-Derived Feedstock and Petroleum-Derived Feedstock

A mixing system is configured according to the embodiment illustrated in FIG. 1 or FIG. 4 and designed to process a total feed rate of 100 mt/hr. Feedstock A is dewatered waste motor oil and is fed at a rate of 80 mt/hr and a temperature of 50° C. Feedstock B is recycled tires which have been pulverized to a particle size of minus 70 mesh (210 μm) and demetalized and is fed at a rate of 20 mt/hr and ambient temperature. These dissimilar hydrocarbon feedstock materials are ordinarily incompatible, such that it would not be possible to create a stable, combined feedstock blend that can be processed using downstream equipment.

For Feedstock A, the optional static inline mixer shown in FIG. 1 or FIG. 4 is omitted. For Feedstock B, which is provided as a solid, the material is conveyed using a screw auger mechanism, and the optional static inline mixer is also omitted. After combining the two dissimilar hydrocarbon feedstock materials, the initial hydrocarbon feedstock mixture is passed through a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstock materials. The resulting hydrocarbon feedstock blend is now sufficiently stable and uniformly blended for processing in downstream equipment.

### Example 5—Mixing of Fabric-Derived Feedstock and Petroleum-Derived Feedstock

A mixing system is configured as shown in FIG. 1 or FIG. 4 and designed to process a total feed rate of 250 mt/hr. Feedstock A is a mixed refinery stream of 60% light cycle oil and 40% slurry oil (FCC-derived) and is fed at a rate of 225 mt/hr and a temperature of 125° C. Feedstock B is a pyrolysis oil derived from mixed textile fabrics and is fed at a rate of 25 mt/hr and a temperature of 110° C. These dissimilar hydrocarbon feedstock materials are ordinarily incompatible, such that it would not be possible to create a stable, combined feedstock blend that can be processed using downstream equipment.

For Feedstock A, the optional static inline mixer shown in FIG. 1 or FIG. 4 is omitted, but the optional static inline mixer is included for Feedstock B. After combining the two dissimilar hydrocarbon feedstock materials, the initial hydrocarbon feedstock mixture is passed through a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstock materials. The resulting hydrocarbon feedstock blend is now sufficiently stable and uniformly blended for processing in downstream equipment.

### Example 6—Mixing of Paper Fiber-Derived Feedstock and Petroleum-Derived Feedstock

A mixing system is configured according to the embodiment illustrated in FIG. 1 or FIG. 4 and designed to process a total feed rate of 100 mt/hr. Feedstock A is a straight-run kerosene derived from U.S. Gulf Coast crude oil and is fed at a rate of 80 mt/hr and a temperature of 40° C. Feedstock B is a pyrolysis oil derived from mixed paper fiber recycling and is fed at a rate of 20 mt/hr and a temperature of 110° C. These dissimilar hydrocarbon feedstock materials are ordinarily incompatible, such that it would not be possible to create a stable, combined feedstock blend that can be processed using downstream equipment.

For Feedstock A, the optional static inline mixer shown in FIG. 1 or FIG. 4 is omitted, but the optional static inline mixer is included for Feedstock B. After combining the two dissimilar hydrocarbon feedstock materials, the initial hydrocarbon feedstock mixture is passed through a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstock materials. The resulting hydrocarbon feedstock blend is now sufficiently stable and uniformly blended for processing in downstream equipment.

### Example 7—Mixing of Municipal Solid Waste-Derived Feedstock, Sewage Sludge-Derived Feedstock. and Petroleum-Derived Feedstock

A mixing system is configured according to the embodiment illustrated in FIG. 2 or FIG. 5 and designed to process a total feed rate of 100 mt/hr. Feedstock A is a straight-run vacuum gas oil derived from North Sea crude oil and is fed at a rate of 75 mt/hr and a temperature of 100° C. Feedstock B is a pyrolysis oil derived from municipal solid waste and is fed at a rate of 12.5 mt/hr and a temperature of 110° C. Feedstock C is a pyrolysis oil derived from municipal sewage sludge and is fed at a rate of 12.5 mt/hr and a temperature of 110° C. These dissimilar hydrocarbon feedstock materials are ordinarily incompatible, such that it would not be possible to create a stable, combined feedstock blend that can be processed using downstream equipment.

For Feedstock A, the optional static inline mixer shown in FIG. 2 is omitted, but the optional static inline mixers are included for Feedstock B and Feedstock C. After combining Feedstocks B and C, they are initially mixed in the additional optional static inline mixer. The pre-mixed hydrocarbon stream of Feedstocks B and C are then combined with Feedstock A, and the resulting combined feedstock mixture is further mixed by a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstock materials. The resulting hydrocarbon feedstock blend is now sufficiently stable and uniformly blended for processing in downstream equipment.

### Example 8—Mixing of Plastic-Derived Feedstock, Biomass-Derived Feedstock, and Waste Tire-Derived Feedstock

A mixing system is configured according to the embodiment illustrated in FIG. 2 or FIG. 5 and designed to process a total feed rate of 100 mt/hr. In this example, there is no petroleum-derived feedstock. Feedstock A is pyrolysis oil derived from biomass (plant matter) and is fed at a rate of 50 mt/hr and a temperature of 110° C. Feedstock B is a pyrolysis oil derived from mixed plastics and is fed at a rate of 25 mt/hr and a temperature of 110° C. Feedstock C is a pyrolysis oil derived from waste tires (demetallized) and is fed at a rate of 25 mt/hr and a temperature of 110° C. These dissimilar hydrocarbon feedstock materials are ordinarily incompatible, such that it would not be possible to create a stable, combined feedstock blend that can be processed using downstream equipment.

In this example, the optional individual static inline mixers shown in FIG. 2 or FIG. 5 are used for all three hydrocarbon feedstocks. However, the optional intermediate static inline mixer on the combined Feedstock B/Feedstock C line is omitted. After passing through their respective individual static inline mixers, the three hydrocarbon feedstock materials are combined and then further mixed in a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstocks. The resulting hydrocarbon feedstock blend is now sufficiently stable and uniformly blended for processing in downstream equipment.

### Example 9—Mixing of Used Cooking Oil and Petroleum-Derived Feedstock

A mixing system is configured according to the embodiment illustrated in FIG. 1 or FIG. 4 and designed to process a total feed rate of 250 metric tonnes per hour (mt/hr). Feedstock A is straight-run vacuum residue derived from distillation of Middle Eastern crude oil and is fed at a rate of 125 mt/hr and a temperature of 150° C. Feedstock B is used cooking oil obtained from restaurants and/or food processing plants and is fed at a rate of 125 mt/hr and a temperature of 150° C. These dissimilar hydrocarbon feedstock materials are ordinarily incompatible, such that it would not be possible to create a stable, combined feedstock blend that can be processed using downstream equipment.

For Feedstock A, the optional static inline mixer shown in FIG. 1 or FIG. 4 is omitted, but the optional static inline mixer is included for Feedstock B. After combining the two dissimilar hydrocarbon feedstock materials, the initial hydrocarbon feedstock mixture is passed through a common static inline mixer in order to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the incompatible feedstock materials. The resulting hydrocarbon feedstock blend is now sufficiently stable and uniformly blended for processing in downstream equipment.

### Example 10—Addition of Catalyst Precursor

A catalyst precursor (molybdenum 2-ethylhexanoate) is added to any of the hydrocarbon feedstock blends of Examples 1-9 to form a conditioned hydrocarbon feedstock containing a well-dispersed catalyst precursor. A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 30-55 ppm of the dispersed catalyst by weight of the feedstock depending on the type of feedstock being processed. The concentration of dispersed catalyst in each of Examples 1-9 can be 35 ppm, 30 ppm, 40 ppm, 45 ppm, 30 ppm, 30 ppm, 45 ppm, 50 ppm, and 30 ppm, respectively. The carrier oil may comprise all or a portion of one of the hydrocarbon feedstock materials, a conventional hydrocarbon diluent, such as atmospheric gas oil, vacuum gas oil, cycle oil, slurry oil, or a combination thereof. If the carrier oil is initially too hot, it can be cooled prior to being mixed with the catalyst precursor. The diluted precursor mixture is combined with the remaining hydrocarbon feedstock materials.

mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 35 ppm of the dispersed catalyst by weight of the feedstock. The carrier oil may comprise all or a portion of one of the hydrocarbon feedstock materials, a conventional hydrocarbon diluent, such as atmospheric gas oil, vacuum gas oil, cycle oil, slurry oil, or a combination thereof. If the carrier oil is initially too hot, it can be cooled prior to being mixed with the catalyst precursor. The diluted precursor mixture is combined with the remaining hydrocarbon feedstock materials.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of mixing a plurality of dissimilar hydrocarbon feedstock materials to form a hydrocarbon feedstock blend for subsequent processing, comprising:
providing a first hydrocarbon feedstock material selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof;
providing a second hydrocarbon feedstock material that differs from the first hydrocarbon feedstock material by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof;
mixing the first and second hydrocarbon feedstock materials by one or more static inline mixers to form an intermediate blend; and
further mixing the intermediate blend by one or more high shear mixers to form the hydrocarbon feedstock blend.

2. The method of claim 1, wherein the first hydrocarbon feedstock material comprises one or more non-petroleum-derived materials and the second hydrocarbon feedstock material comprises one or more petroleum-derived materials.

3. The method of claim 1, further comprising mixing a third hydrocarbon feedstock material with the first and second hydrocarbon feedstock materials to form the hydrocarbon feedstock blend, wherein the third hydrocarbon feedstock material differs from the first and second hydrocarbon feedstock materials by at least one of chemical composition, polarity, solubility, or physical state, and wherein the third hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof.

4. The method of claim 1, wherein the hydrocarbon feedstock materials are mixed using a plurality of parallel mixing lines, each parallel mixing line including one or more static inline mixers, one or more high shear mixers, and at least one valve for regulating flow in the mixing line.

5. The method of claim 1, wherein the biomass-derived material is selected from the group consisting of plant-derived material, lignocellulose, cellulose, lignin, starch, wood, wood residues, sawdust, wood chips, energy crops, hemp, straw, wheat straw, barley straw, stover, grasses, switch grass, maize, miscanthus, bamboo, husks, bagasse, silage, agriculture waste, seaweed, kelp, algae, pyrolysis products of one or more of the foregoing, and combinations thereof.

6. The method of claim 1, wherein the non-petroleum-derived oil or fat is selected from the group consisting of vegetable oil or fat, animal fat or protein, used cooking oil, seed oil, non-petroleum wax, pyrolysis products of one or more of the foregoing, and combinations thereof.

7. The method of claim 1, wherein the polymer is selected from the group consisting of high-density polyethylene (HDPE), low-density polyethylene (LDPE), polypropylene (PP), polystyrene (PS), polyester (PE), polyethylene terephthalate (PET), polybutylene terephthalate (PBT), polyetheretherketone (PEEK), polycarbonate (PC), acrylic, polymethacrylate, biopolymer, phenol-formaldehyde condensate, polyvinylchloride (PVC), bisphenyl-A, polyurethane (PUR), bioplastics, polyhydroxyalkanoate (PHA), polyhydroxy-butyrate (PHB), pyrolysis products of one or more of the foregoing, and combinations thereof.

8. The method of claim 1, wherein the fabric or textile is a product or structure comprising or derived from one or more materials or structures selected from the group consisting of cotton, polyester, linen, jute, nylon, spandex, wool, silk, leather, cloth, clothing, towels, rags, upholstery, carpet, geotextiles, drapes, shades, blinds, baskets, tablecloths, bedding, sheets, blankets, shower curtains, flags, backpacks, tents, nets, balloons, kites, sails, parachutes, pyrolysis products of one or more of the foregoing, and combinations thereof.

9. The method of claim 1, wherein the rubber is selected from the group consisting of isoprene, neoprene, tires, polybutadiene, styrene-butadiene copolymer, butyl rubber, ethylene propylene rubber, styrene-ethylene-butylene-styrene (SEBS), acrylic rubber, thermoplastic elastomer (TPE), pyrolysis products of one or more of the foregoing, and combinations thereof.

10. The method of claim 1, wherein the waste product is selected from the group consisting of municipal solid waste (MSW), sewage sludge, food processing waste, meat-processing waste, industrial waste products, pyrolysis products of one or more of the foregoing, and combinations thereof.

11. The method of claim 1, wherein the petroleum-derived material is selected from the group consisting of vacuum residue (straight-run or product from hydrocracking or hydroconversion process), vacuum gas oil (straight-run or product from hydrocracking or hydroconversion process), atmospheric residue, atmospheric gas oil, bitumen, visbreaker bottoms, resid pitch, heavy oil, deasphalted heavy oil, fluid catalytic cracking (FCC)-derived oil, slurry oil, cycle oil (light cycle oil or heavy cycle oil), decant oil, petroleum-based pyrolysis oil, waste motor oil, diesel, kerosene, hydrocarbon distillates having a nominal boiling in a range of 200° C. to 524° C., and combinations thereof.

12. The method of claim 1, further comprising liquifying or comminuting any initially solid hydrocarbon feedstock materials to a particle size of about 50 mesh (about 300 μm) or smaller, or about 70 mesh (about 210 μm) or smaller, or about 100 mesh (about 150 μm) or smaller.

13. The method of claim 1, wherein the hydrocarbon feedstock blend comprises 0% to 50% by weight of petroleum-derived material and 50% to 100% by weight of non-petroleum-derived material.

14. The method of claim 1, wherein the hydrocarbon feedstock blend comprises 10% to 99% by weight of petroleum-derived material and 1% to 90% by weight of non-petroleum-derived material.

15. The method of claim 1, further comprising recycling a portion of the hydrocarbon feedstock blend by combining the recycled portion with at least one of the hydrocarbon feedstock materials prior to forming the intermediate blend.

16. The method of claim 1, further comprising processing the hydrocarbon feedstock blend or upstream intermediate blend by processing equipment selected from the group consisting of strainers, filters, pumps, furnaces, heat exchangers, reactors, separators, tanks, and distillation columns.

17. The method of claim 1, further comprising processing the hydrocarbon feedstock blend by one or more of ebullated bed hydrocracking or hydroconversion, fixed bed hydrocracking or hydroconversion, slurry bed hydrocracking or hydroconversion, solvent deasphalting, coking (delayed coking and/or Flexicoking), fluid catalytic cracking, hydroprocessing, or hydrotreating.

18. The method of claim 1, further comprising dispersing an oil-soluble catalyst precursor into the hydrocarbon feedstock blend, such as by initially mixing the oil-soluble catalyst precursor with a carrier oil to form a diluted precursor mixture that is mixed into the hydrocarbon feedstock blend, such as by at least one of inline mixing or high shear mixing, preferably where the carrier oil is selected from the group consisting of atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C.

19. A method of mixing a plurality of dissimilar hydrocarbon feedstock materials to form a hydrocarbon feedstock blend for subsequent processing, comprising:
providing a first hydrocarbon feedstock material comprised of at least one petroleum-derived feedstock material;
providing a second hydrocarbon feedstock material comprised of at least one non-petroleum-derived feedstock material and that differs from the first hydrocarbon feedstock material by at least one of chemical composition, polarity, solubility, or physical state, wherein the at least one non-petroleum-derived feedstock material is selected from the group consisting of biomass-derived material, non-petroleum-derived oil or fat, polymer, fabric or textile, paper or cardboard, rubber, waste product, pyrolysis product of one or more of the foregoing, and combinations thereof;
mixing the first and second hydrocarbon feedstock materials in one or more static inline mixers to form an intermediate blend; and
further mixing the intermediate blend in one or more high shear mixers to form the hydrocarbon feedstock blend.

20. The method of claim 19, further comprising mixing a third hydrocarbon feedstock material with the first and second hydrocarbon feedstock materials to form the hydrocarbon feedstock blend, wherein the third hydrocarbon feedstock material differs from the first and second hydrocarbon feedstock materials by at least one of chemical composition, polarity, solubility, or physical state, and wherein the third hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof.

21. A system for blending a plurality of dissimilar hydrocarbon feedstock materials to form a hydrocarbon feedstock blend for subsequent processing comprising means for performing the method steps recited in claim 1.

22. A system for blending a plurality of dissimilar hydrocarbon feedstock materials to form a hydrocarbon feedstock blend for subsequent processing, comprising:
a first hydrocarbon feedstock stream selected from the group consisting of biomass-derived material, non-petroleum-derived oil or fat, polymer, fabric or textile, paper or cardboard, rubber, waste product, pyrolysis product of one or more of the foregoing, petroleum-derived feedstock material, and combinations thereof;
a second hydrocarbon feedstock stream that differs from the first hydrocarbon feedstock stream by at least one of chemical composition, polarity, solubility, or physical state, wherein the second hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived feedstock material, and combinations thereof;
one or more static inline mixers configured to receive and mix the first and second hydrocarbon feedstock materials to form an intermediate blend; and
one or more high shear mixers configured to receive and further mix the intermediate blend to form the hydrocarbon feedstock blend.

23. The system of claim 22, further comprising:
a third hydrocarbon feedstock stream that differs from the first and second hydrocarbon feedstock materials by at least one of chemical composition, polarity, solubility, or physical state, and wherein the third hydrocarbon feedstock material is selected from the group consisting of biomass-derived material, non-petroleum-derived oil or fat, polymer, fabric or textile, paper or cardboard, rubber, waste product, pyrolysis product of one or more of the foregoing, petroleum-derived material, and combinations thereof; and
at least one other inline static mixer configured to receive and mix the third hydrocarbon feedstock stream with the second hydrocarbon feedstock material upstream from the one or more static inline mixers that form the intermediate blend.

24. The system of claim 23, the system comprising:
a plurality of parallel mixing lines configured to receive and mix the hydrocarbon feedstock materials, each parallel mixing line including one or more static inline mixers, one or more high shear mixers, and at least one valve for regulating flow in the mixing line; and
a recycle line configured to recycle a portion of the hydrocarbon feedstock blend and combine the recycled portion with at least one of the hydrocarbon feedstock materials upstream from the one or more static inline mixers that form the intermediate blend.
